(19) United States
(12) Patent Application Publication
(10) Pub. No.: US 2025/0059379 A1
(43) Pub. Date: Feb. 20, 2025

(54) PAINTS CONTAINING DRIERS BASED ON VANADIUM COMPOUNDS BEARING VARIOUS ACID ANIONS

(71) Applicant: Borchers GmbH, Langenfeld (DE)

(72) Inventors: Neil John Simpson, Bearsden (GB); Martin Klussmann, Langenfeld (DE); Joshua Halstead, Hinckley, OH (US); Steffen Brand, Hilden North Rhine-Westphalia (DE)

(73) Assignee: Borchers GmbH, Langenfeld (DE)

(21) Appl. No.: 18/722,953

(22) PCT Filed: Dec. 7, 2022
(86) PCT No.: PCT/EP2022/084743

§ 371 Date: Jun. 21, 2024

Related U.S. Application Data
(60) Provisional application No. 63/292,499, filed on Dec. 22, 2021.

(30) Foreign Application Priority Data
Jan. 3, 2022 (EP) 22150047.3

(51) Int. Cl. C09D 5/00; C08K 3/11; C08K 3/22; C08K 3/24; C09D 7/61; C09D 7/63; C09D 167/08; C09F 9/00

(52) U.S. Cl. CPC C09D 5/00; C08K 3/11; C08K 3/24; C09D 7/61; C09D 7/63; C09D 167/08; C09F 9/00; C08K 2003/2241

(57) ABSTRACT

The invention pertains generally to paints containing a binder curable by an autoxidation mechanism and at least one drier comprising a sulfonate compound of vanadium of formula (VII) where R¹ and R² are independently selected from a group involving hydrogen, C₁-C₁₂ alkyl, C₁-C₁₂ halogenated alkyl, C₆-C₁₀ aryl, benzyl; and whereas aryl and benzyl can be optionally substituted by up to three substituents independently selected from a group involving C₁-C₂₀ alkyl, and hydroxy(C₁-C₂)alkyl in combination with at least one inorganic acid and optionally in combination with at least one organic acid.

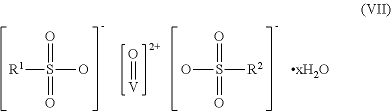

### CROSS-REFERENCE TO RELATED APPLICATIONS

This application is a national stage application, filed under 35 U.S.C. § 371, of International Patent Application No. PCT/EP2022/084743 filed on Dec. 7, 2022, which claims the benefit of and priority to European patent application number EP22150047.3 filed on Jan. 3, 2022 and U.S. provisional patent application No. 63/292,499 filed on Dec. 22, 2021, the disclosures of each of which are hereby incorporated by reference in their entirety.

### TECHNICAL FIELD

The invention described herein pertains generally to the formulation of air-drying paints and primary driers suitable for these formulations in combination with inorganic acids.

### BACKGROUND OF THE INVENTION

Air-drying binders, including polyester resins modified by plant oils known as alkyd resins, are widely used in paint-producing industry due to low price, high content of biologically renewable sources and relatively easy biodegradability (Hofland, A., Prog. Org. Coat., 73, 274-282 (2012)). Synthetic resins modified by drying and semidrying plant oils are cured by the action of air oxygen. Chemical process, known as autoxidation, is responsible for transformation of the liquid paint layer to solid and durable coating. As the autoxidation proceeds sluggishly at ambient conditions, it is commonly accelerated by the action of special catalysts known as primary driers. These compounds enable faster decomposition of hydroperoxides those are kinetically stable intermediates of autoxidation generated in the first step of the curing process. It results in considerable acceleration of subsequent reactions in propagation step of autoxidation producing radicals determining final structure of cured resins. Crosslinking of the airdrying paints proceeds through addition of the radicals on the double bond systems and radical recombination in the termination step (Soucek, M. D. et. al; Prog. Org. Coat., 73, 435-454 (2012)).

Cobalt carboxylates soluble in organic solvents, such as cobalt 2-ethylhexanoate, cobalt neodecanoate and cobalt naphthenate, are currently widely used in paint-producing industry as primary driers due to high catalytic activity in solvent-borne and high solid air-drying binders (Honzifek, J.; Ind. Eng. Chem. Res. 58, 12485-12505 (2019)). However, application of the cobalt compounds should be restricted legislatively in near future due to healthy and ecological issues (Leyssens, L. et al.; Toxicology 387, 43-56 (2017); Simpson, N. et al; Catalysts, 9, 825 (2019)). Currently, cobalt carboxylates are under in-depth scrutiny of European Chemicals Agency and preliminarily classified as suspect reproductive toxicants.

Ongoing toxicological investigation might lead to reclassification to carcinogens and their prohibition on their use in commercial paints. Such circumstances accelerate research in field of iron and manganese-based catalysts capable to replace cobalt-based driers (WO 2008/003652 A1; Simpson, N. et al; Catalysts, 9, 825 (2019), Matǔsková, E. et al; Materials, 13, 642 (2020). Vanadium-based compounds, soluble in organic solvents, are another alternative for cobalt carboxylates reported in research and patent literature. They include oxidovanadium compounds bearing carboxylates (EP 0 304 149 B1, U.S. Pat. No. 6,063,841 A, Preininger, O. et al; J. Coat. Technol. Res. 13, 479-487 (2016)), acetylacetonates (U.S. Pat. No. 6,063,841 A, Preininger, O. et al; Prog. Org. Coat. 88, 191-198 (2015), Preininger, O. et al; Inorg. Chim. Acta 462, 16-22 (2017), Charamzová, I. et al; Inorg. Chim. Acta 492, 243-248 (2019)), ketiminates (U.S. Pat. No. 6,063,841 A), organophosphates (U.S. Pat. No. 6,063,841 A) and dithiocarbamates (CZ 307597 B6, Charamzová, I. et al; J. Coat. Technol. Res. 2020, 17, 1113-1122.). Some of these compounds were found to be suitable as secondary driers improving visual and mechanic properties of the final paint films (WO 2015/082553 A1, WO 2017/085154 A1, WO 2010/106033 A1). It is noteworthy that none of the reported vanadium-based drier found commercial application owing to low solubility, high production costs or low stability upon storage. This invention brings a replacement to toxic cobalt that can be used in both water and solvent-borne paints. Enabling water-based alkyd use is of critical importance in reducing volatile organic compounds for the environment. The replacement of both organic solvents and toxic catalysts is of critical importance as the chemical industry looks for more sustainable and environmentally friendly alternatives to existing technologies.

The invention relates to vanadium-based driers (see M. Petranikova, A. H. Tkaczyk, A. Bartl, A. Amato, V. Lapkovskis and C. Tunsu, “Vanadium sustainability in the context of innovative recycling and sourcing development”, Waste Management 113 (2020) 521,544) with improved properties available from readily available raw materials through simple one-step route. The invented driers should further exhibit high stability toward air-oxygen. Their solubility should be easily modified through substitution pattern of given sulfonate anion allowing other driers to dissolve in a variety of organic solvents and water in combination with at least one inorganic acid, selected from the group consisting of the inorganic acid selected from the group consisting of phosphoric acid, hydrochloric acid, nitric acid, sulphuric acid, boric acid, hydrobromic acid, perchloric acid, and hydroiodic acid and combinations and blends thereof with other inorganic acids as well as in combination with other organic acids. They should be suitable for different types of air-drying paints.

Czech Patent Application No. PV 2020-366, filed on 24 Jun. 2020, titled “Nátěrové hmoty obsahujicí sikativy na bézi sloučenin vanadu s kompenzujícími anionty sulfonových kyselin” which translates as “Paints containing driers based on vanadium compounds bearing anions of sulfonic acids as counter ions” describes vanadium compounds using sulfonic acid anions.

### SUMMARY OF THE INVENTION

The present invention is directed to vanadium-based driers in combination with at least one inorganic acid as well as in blends with at least one organic acid.

One aspect of the invention involves formulating a paint formulation comprising: a binder curable by autoxidation mechanism; and at least one drier comprising a vanadium compound of the formula (VII)

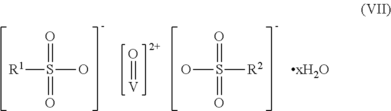

where R¹ and R² are independently selected from a group involving hydrogen, C₁-C₁₂ alkyl, C₁-C₁₂ halogenated alkyl, C₆-C₁₀ aryl, benzyl; and whereas aryl and benzyl can be optionally substituted by up to three substituents independently selected from a group involving C₁-C₂₀ alkyl, and hydroxy(C₁-C₂)alkyl in combination with at least one inorganic acid.

In another aspect of the invention, the binder curable by autoxidation mechanism is selected from the group consisting of alkyd resin, epoxy ester resin and resin modified by plant oils or fatty acids.

In yet another aspect of the invention, the formulation comprises one or more sulfonate compounds of vanadium of formula (VII) in overall concentration at least 0.001 wt. % to 0.3 wt. % in dry material content of the paint, more preferably at least between 0.003 to 0.3 wt. % in dry material content of the paint, and most preferably at least between 0.006 to 0.06 wt. % in dry material content of the paint.

In still yet another aspect of the invention, depending on the application, the driers based on formula (VII) can be dissolved in water or polar organic solvents, e.g. dimethyl sulfoxide (DMSO), acetic acid, alcohols, esters, ethers, solvents with more than one functional group of alcohols, esters and ethers, and their mixtures.

In the paint formulation, the C₁-C₁₂ halogenated alkyl is a C₁-C₁₂ fluorinated alkyl.

In one aspect of the invention, the paint formulation comprises water, whereas in another aspect of the invention, the paint formulation of is non-aqueous.

The paint formulation further comprises a ligand selected from the group consisting of Bispidon, N4py type, TACN-type, Cyclam and cross-bridged ligands, and Trispicen-type ligands.

The paint formulation further comprises a metal-ligand complex, e.g., iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) illustrated below

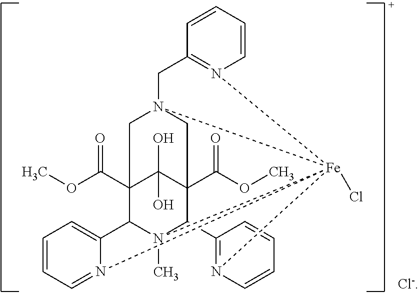

The paint formulation may optionally comprise a pigment and optionally include an organic acid e.g., oxalic acid in combination with an inorganic acid.

The paint formulation alkyd resin may be a solvent-borne or a water-borne resin and the end-use application is often a formulation for a paint.

The invention includes the use of formula (VII) wherein the compound of formula (VII) is dissolved in dimethyl sulfoxide, esters, ethers, solvents with more than one functional group of alcohols, esters, ethers or alcohol or water or a mixture thereof before being incorporated into the paint.

The invention further includes the use of a sulfonate vanadium compound of formula (VII)

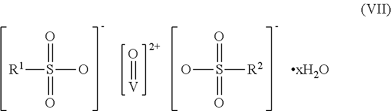

wherein R¹ and R² are independently selected from a group consisting of hydrogen, C₁-C₁₂ alkyl, C₁-C₈ fluorinated alkyl, C₆-C₁₀ aryl, benzyl; wherein the C₆-C₁₀ aryl and benzyl can be optionally substituted by one up to three substituents independently selected from a group involving C₁-C₂₀ alkyl and hydroxy(C₁-C₂)alkyl, in dimethyl sulfoxide, esters, ethers, solvents with more than one functional group of alcohols, esters, ethers, alcohol or a mixture thereof, as a drier for paints containing a curable binder.

These and other objects of this invention will be evident when viewed in light of the detailed description and appended claims.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

The invention has broad utility in relation to a wide variety of solvent and water-based coating compositions, which term is to be interpreted broadly herein. Examples of coating compositions include clear or colored varnishes, primary coats, filling pastes, glazes, emulsions and floor coverings, e.g. linoleum floor coverings. Embodiments of the invention relate to solvent and water-based paints and inks, particularly paints such as high-specification paints intended for domestic use and paints intended for general industrial applications.

Use of the term “oxidatively curable coating compositions” herein is thus intended to embrace a wide variety of colored (e.g. by way of pigment or ink) and non-colored materials, including oils and binders, which form a continuous coating through the course of oxidative reactions, typically to form cross-linkages and other bond formations. Generically, such coating compositions may be characterized by the presence of typically (poly) unsaturated resins that react to form a solid film on a substrate, the resins being initially present in the oxidatively curable solvent-based coating compositions either as liquids, dissolved in an organic solvent or as solids dispersed in a continuous liquid phase. Reaction to form the desired coating upon curing arises from polymerization reactions initiated by oxidation. Examples of oxidatively curable coating compositions include alkyd-, acrylate-, urethane-, polybutadiene- and epoxy ester-based resins. Typically, the curable (e.g. alkyd resin) portion of the curable composition will comprise between about 1 and about 90% by weight of the total weight of the oxidatively curable solvent-based coating composition, e.g. between about 20 wt. % and about 70% wt. % of the total weight of the oxidatively curable solvent-based coating composition.

Alkyd resins are a particularly important member of the class of oxidatively curable coating compositions and are a well-studied class of resin to which the present invention may be applied. Hereinafter, embodiments of the invention are described with reference to the use of alkyd resins, also referred to as alkyd-based resins or alkyd(-based) binders. Whilst these represent particularly significant embodiments of the invention, the invention is not to be so limited. To be clear: the invention is applicable to a wide range of oxidatively curable coating compositions, typically those comprising at least 1 or 2% by weight of an unsaturated compound (e.g., comprising unsaturated (non-aromatic) double or triple carbon-carbon bonds).

As used herein, the term “alkyd binder” or “alkyd resin” are used interchangeably. Suitable autoxidizable alkyd resin for use in the invention, are in general the reaction product of the esterification of polyhydric alcohols with polybasic acids (or their anhydrides) and unsaturated fatty acids (or glycerol esters thereof), for example derived from linseed oil, tung oil, tall oil as well as from other drying or semi-drying oils. Alkyd resins are well-known in the art and need not to be further described herein. The properties are primarily determined by the nature and the ratios of the alcohols and acids used and by the degree of condensation. Suitable alkyd resins include long oil and medium oil alkyd resins e.g., derived from 45 wt. % to 70 wt. % of fatty acids. To improve the performance of the resins, the composition of the long oil and medium oil alkyd may be modified. For example, polyurethane modified alkyds, silicone modified alkyds, styrene modified alkyds, acrylic modified alkyds (e.g. (meth)acrylic modified alkyds), vinylated alkyds, polyamide modified alkyds, and epoxy modified alkyds or mixtures thereof are also suitable alkyd resins to be used in the present composition.

Preferably, the at least one autoxidizable alkyd binder is selected from a medium or long oil unmodified alkyd, a silicone modified alkyd, a polyurethane modified alkyd or a combination thereof. Most preferably, the alkyd binder is a long oil (unmodified) alkyd, a silicone modified alkyd, a polyurethane modified alkyd or a combination thereof.

The amount of alkyd binder in the present compositions can typically range from about 20 wt. % to 98 wt. %, such as about 30 wt. % to about 90 wt. %, preferably about 35 wt. % to 70 wt. % based on the total weight of the composition.

As used herein, the term “driers” (which are also referred to synonymously as “siccatives” when in solution) refers to organometallic compounds that are soluble in organic solvents and binders. They are added to unsaturated oils and binders in order to appreciably reduce their drying times, i.e., the transition of their films to the solid phase. Driers are available either as solids or in solution. Suitable solvents are organic solvents and binders. The driers are present in amounts expressed as weight percent of the metal based on the weight of binder solids (or resin) unless stated otherwise.

As used herein, the term “drier composition” refers to the mixture of driers as presently claimed. The drier composition according to the invention can comprises several drier compounds. The inventors have found that the present selection of driers in a coating composition improves the drying speed of the coating composition.

Where percentages by weight are referred to herein (wt. % or % w/w), this means, unless a context clearly dictates to the contrary, percentages by weight with respect to the solid resin resultant from curing, i.e. components of the oxidatively curable coating compositions that serve to provide the coating upon curing. With an oxidatively curable alkyd coating composition, therefore, the combined weights of the components of the composition that become, i.e., are incorporated into, the alkyd resin coating, i.e., once cured, are those with respect to which weight percentages herein are based. For example, the composition, either resultant from conducting the method according to the first aspect of the invention, or according to the second aspect of the invention, typically comprises about 0.0001 to about 1% w/w, e.g., about 0.0005 to about 0.5% w/w water, or about 0.01 to about 1% w/w, e.g. about 0.05 to about 0.5% w/w water, based on the components of the composition that, when cured, from the coating.

By oxidatively curable solvent-based compositions is meant herein, consistent with the nomenclature used in the art, compositions that are based on organic (i.e., non-aqueous) solvents. Examples of suitable solvents include aliphatic (including alicyclic and branched) hydrocarbons, such as hexane, heptane, octane, cyclohexane, cycloheptane and isoparaffins; aromatic hydrocarbons such as toluene and xylene; ketones, e.g. methyl ethyl ketone and methyl isobutyl ketone; alcohols, such as isopropyl alcohol, n-butyl alcohol and n-propyl alcohol; glycol monoethers, such as the monoethers of ethylene glycol and diethylene glycol; monoether glycol acetates, such as 2-ethoxyethyl acetate; as well as mixtures thereof. Isomeric variants are included. Thus, the term hexane embraces mixtures of hexanes. According to embodiments of the invention, the solvent is a hydrocarbyl (i.e., hydrocarbon) solvent, e.g., an aliphatic hydrocarbyl solvent, e.g., solvents comprising mixtures of hydrocarbons. Examples include white spirit and solvents available under the trademarks Shellsol, from Shell Chemicals and Solvesso and Exxsol, from Exxon.

The compositions by the invention comprise a transition metal drier, which is a complex of a transition metal ion and a sulfonic acid counter ion. Each of these will now be described.

The transition metal ion used in the invention is vanadium. The valency of the metal may range from +2 to +5. Embodiments of the invention mixtures of transition metal ions. Where a vanadium-containing drier is provided this is usually as a V(II), (III), (IV) or (V) compound, where an iron-containing drier is provided, this is usually as an Fe(II) or Fe(III) compound. Where a manganese drier is provided, this is usually as a Mn (II), (III) or (IV) compound.

To enhance the activity of the transition metal ions a so-called accelerating compound, such as a carboxylic acid or a pentadentate amine, is also included. As the language suggests the carboxylic acid or polydentate amine accelerant ligand is a compound capable of coordinating to the transition metal ion by way of more than one donor site within the ligand and serves to accelerate the drying (curing process) of the oxidatively curable coating composition after application.

According to some embodiments of the invention the polydentate amine accelerant ligand is a bi-, tri-, tetra-, penta- or hexadentate ligand coordinating through nitrogen and/or oxygen donor atoms. In particular embodiments of the invention the ligand is a bi-, tri-, tetra-, penta- or hexadentate nitrogen donor ligand, in particular a tri-, tetra-, penta-, or hexadentate nitrogen donor ligand. However, the invention is not so limited. Examples of a wide variety of polydentate accelerant ligands are discussed below.

The metal drier, as described herein, e.g., as a pre-formed complex of transition metal ion(s) and polydentate accelerant ligand(s)), is typically dissolved in water at a concentration of about 0.001 to about 10 wt. %, e.g., about 0.01 to about 5 wt. %, or about 0.001 to about 1 wt. %, based on the weight of water. Increasing the concentration of the metal drier in the aqueous solution allows a relatively smaller volume of the metal drier-containing aqueous solution to be added to the coating composition. This may be desired by the skilled person. The actual amount of the metal drier depends on the number of metal atoms present in the metal drier molecule and its total molecular weight, as well as the desired degree of its incorporation. For example, if the molecular weight of a desired complex is 560 and contains one iron ion (mw 56) and a level of 0.1% of iron is mentioned, the amount of compound dissolved in water is 1% (w/w) or 10 gram/kg water. If the complex is not preformed but formed in-situ, a metal salt will also be typically dissolved in water at a concentration of about 0.001 to about 1 wt. % based on the metal ion to water ratio. An appropriate amount of polydentate accelerant ligand can then be added to form the desired complex.

After preparation, a solution of the metal drier may then be contacted with, e.g., added to, a coating composition.

The resultant composition, comprising the metal drier, and typically from 0.0001 to 1% of water, based on the weight of the oxidatively curable resin, will typically be a solution, i.e., a single homogeneous phase. However, it may also be an emulsion or dispersion, e.g., comprising discontinuous regions of aqueous solution comprising the transition metal drier.

As used in this application, the term “Binder solutions (alkyds)” means one of the following: SYNAQUA 4804 (water-borne short oil alkyd, Arkema); SYNAQUA 2070 (water-borne medium oil alkyd, Arkema); Beckosol AQ101 (water-borne long oil alkyd, Polyont Composites USA Inc.); WorleeKyd S 351 (solvent-borne medium oil alkyd, Worlee); and TOD 3AK0211Y (water-reducible alkyd, TOD, China) and other binder solutions having similar characteristics to the named above. In a more generic sense, “alkyd resin(s)” means a synthetic resin made by condensation reaction (release of water) between a polyhydric alcohol (glycerol, etc.) and dibasic acid (or phthalic anhydride). It is the non-volatile portion of the vehicle of a paint. After drying, it binds the pigment particles together with the paint film as a whole.

As used in this application the term “Catalysts” means: Borchi Oxy-Coat 1101 (BOC 1101, in water, Borchers); Borchi Oxy-Coat (BOC, in propylene glycol, Borchers); Borchers Deca Cobalt 7 aqua (Co-neodecanoate drier, in organic solvents, Borchers); Borchers Deca Cobalt 10 (Co-neodecanoate drier, in hydrocarbon solvents, Borchers); Cur-Rx (Vanadium 2-ethylhexanoate drier, Borchers); Vanadyl acetylacetonate (VO(acac)₂) (99%, CAS: 14024-18-1, Acros); V-TS (Vanadium-based drier, 9.4% V); V-DS (Vanadium-based drier, 5.5% V) and other catalysts having similar characteristics to the named above.

As used in this application, the term “Ligands” preferably means TMTACN—N,N,N-Trimethyl-1,4,7-triazacyclononane and other ligands having similar characteristics to the named above and illustrated below.

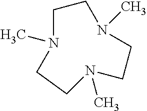

Other applicable “ligands” would include the following:

### Bispidon

The bispidon class are typically in the form of an iron transition metal catalyst. The bispidon ligand is preferably of the formula:

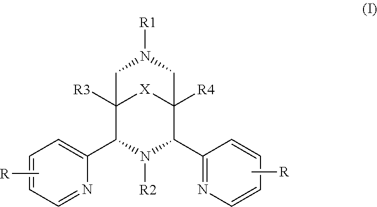

wherein:
each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄-alkyl, and C₁₋₄-alkyl;
R1 and R2 are independently selected from the group consisting of C₁₋₂₄-alkyl, C₆₋₁₀-aryl, and a group containing one or two heteroatoms (e.g. N, O or S) capable of coordinating to a transition metal;
R3 and R4 are independently selected from the group consisting of hydrogen, C₁₋₈-alkyl, C₁₋₈-alkyl-O—C₁₋₈-alkyl, C₁₋₈-alkyl-O—C₆₋₁₀-aryl, C₆₋₁₀-aryl, C₁₋₈-hydroxyalkyl and —(CH₂)ₙC(O)OR5 wherein R5 is independently selected from hydrogen and C₁₋₄-alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.

Often R3=R4 and is selected from —C(O)—O—CH₃, —C(O)—O—CH₂CH₃, —C(O)—O—CH₂C₆H₅ and CH₂OH. Often the heteroatom capable of coordinating to a transition metal is provided by pyridin-2-ylmethyl optionally substituted by C₁₋₄-alkyl or an aliphatic amine optionally substituted by C₁₋₈-alkyl. Often X is C═O or C(OH)₂.

Typical groups for —R1 and —R2 are —CH₃, —C₂H₅, —C₃H₇, -benzyl, —C₄H₉, —C₆H₁₃, —C₈H₁₇, —C₁₂H₂₅, and —C₁₈H₃₇ and -pyridin-2-yl. An example of a class of bispidon is one in which at least one of R1 or R2 is pyridin-2-ylmethyl or benzyl or optionally alkyl-substituted amino-ethyl, e.g. pyridin-2-ylmethyl or N,N-dimethylamino-ethyl.

Two examples of bispidons are dimethyl 2,4-di-(2-pyridyl)-3-methyl-7-(pyridin-2-ylmethyl)-3,7-diaza-bicyclo[3.3.1]nonan-9-one-1,5-dicarboxylate (N2py3o-C1) and dimethyl 2,4-di-(2-pyridyl)-3-methyl-7-(N,N-dimethyl-amino-ethyl)-3,7-diaza-bicyclo[3.3.1]nonan-9-one-1,5-dicarboxylate and the corresponding iron complexes thereof. FeN2py3o-C1 may be prepared as described in WO 02/48301. Other examples of bispidons are those which, instead of having a methyl group at the 3-position, have longer alkyl chains (e.g. C₄-C₁₈alkyl or C₆-C₁₈alkyl chains) such as isobutyl, (n-hexyl) C₆, (n-octyl) C₈, (n-dodecyl) C₁₂, (n-tetradecyl) C₁₄, (n-octadecyl) C₁₈; these may be prepared in an analogous manner.

### N4py Type

The N4py type ligands are typically in the form of an iron transition metal catalyst. The N4py type ligands are typically of the formula (II):

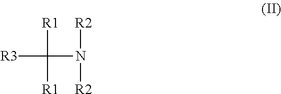

wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

Accordingly to some embodiments R1 or R2 represents pyridin-2-yl; or R2 or R1 represents 2-amino-ethyl, 2-(N-(m)ethyl)amino-ethyl or 2-(N,N-di(m)ethyl)amino-ethyl. If substituted, R5 often represents 3-methyl pyridin-2-yl. R3 preferably represents hydrogen, benzyl or methyl.

Examples of N4Py ligands include N4Py itself (i.e. N, N-bis(pyridin-2-yl-methyl)-bis(pyridin-2-yl)methylamine which is described in WO 95/34628); and MeN4py (i.e. N,N-bis(pyridin-2-yl-methyl-1,1-bis(pyridin-2-yl)-1-aminoethane) and BzN4py (N,N-bis(pyridin-2-yl-methyl-1,1-bis(pyridin-2-yl)-2-phenyl-1-aminoethane) which are described in EP 0 909 809.

### TACN-Type

The TACN-Nx are preferably in the form of an iron transition metal catalyst. These ligands are based on a 1,4,7-triazacyclononane (TACN) structure but have one or more pendent nitrogen groups that serve to complex with the transition metal to provide a tetradentate, pentadentate or hexadentate ligand. According to some embodiments of the TACN-Nx type of ligand, the TACN scaffold has two pendent nitrogen-containing groups that complex with the transition metal (TACN-N2). TACN-Nx ligands are typically of the formula (III):

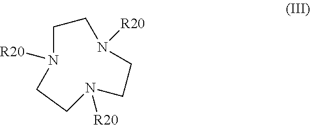

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
wherein at least one of R20 is a —CY₂—R22.

R22 is typically selected from optionally alkyl-substituted pyridin-2-yl, imidazol-4-yl, pyrazol-1-yl, quinolin-2-yl groups. R22 is often either a pyridin-2-yl or a quinolin-2-yl.

### CYCLAM and Cross-Bridged Ligands

The cyclam and cross-bridged ligands are preferably in the form of a manganese transition metal catalyst. The cyclam ligand is typically of the formula (IV):

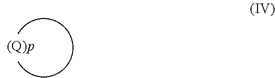

wherein:
Q is independently selected from

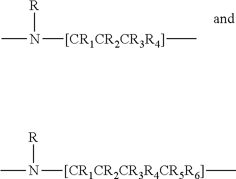

p is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

Examples of non-cross-bridged ligands are 1,4,8,11-tetraazacyclotetradecane (cyclam), 1,4,8,11-tetramethyl-1,4,8,11-tetraazacyclotetradecane (Me4cyclam), 1,4,7,10-tetraazacyclododecane (cyclen), 1,4,7,10-tetramethyl-1,4,7,10-tetraazacyclododecane (Me4cyclen), and 1,4,7,10-tetrakis(pyridine-2ylmethyl)-1,4,7,10-tetraazacyclododecane (Py4cyclen). With Py4cyclen the iron complex is preferred.

A preferred cross-bridged ligand is of the formula (V):

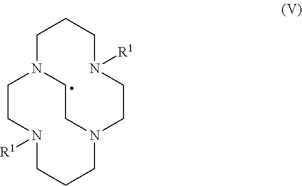

wherein
R¹ is independently selected from H, C₁₋₂₀-alkyl, C₇₋₄₀-alkylaryl, C₂₋₆-alkenyl or C₂₋₆-alkynyl.

All nitrogen atoms in the macropolycyclic rings may be coordinated with a transition metal. In formula (VI), each R¹ may be the same. Where each R¹ is Me, this provides the ligand 5,12-dimethyl-1,5,8,12-tetraaza-bicyclo[6.6.2]hexadecane (L) of which the complex [Mn(L)Cl₂] may be synthesised according to WO 98/39098. Where each R1=benzyl, this is the ligand 5,12-dibenzyl-1,5,8,12-tetraaza-bicyclo[6.6.2]hexadecane (L′) of which the complex [Mn(L′)Cl₂] may be synthesised as described in WO 98/39098. Further suitable crossed-bridged ligands are described in WO98/39098.

### TRISPICEN-Type

The trispicens are preferably in the form of an iron transition metal catalyst. The trispicen type ligands are preferably of the formula (VI):

R17R17N—X—NR17R17 (VI),

wherein:
X is selected from —CH₂CH₂—, —CH₂CH₂CH₂—, —CH₂C(OH)HCH₂—;
each R17 independently represents a group selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

The heteroatom donor group is preferably pyridinyl, e.g. 2-pyridinyl, optionally substituted by —C₁-C₄-alkyl.

Other preferred heteroatom donor groups are imidazol-2-yl, 1-methyl-imidazol-2-yl, 4-methyl-imidazol-2-yl, imidazol-4-yl, 2-methyl-imidazol-4-yl, 1-methyl-imidazol-4-yl, benzimidazol-2-yl and 1-methyl-benzimidazol-2-yl. Preferably three of R17 are CY₂—R18.

The ligand Tpen (N, N, N′, N′-tetra(pyridin-2-yl-methyl)ethylenediamine) is disclosed in WO 97/48787. Other suitable trispicens are described in WO 02/077145 and EP 1 001 009 A.

Preferably, the ligand is selected from dimethyl 2,4-di-(2-pyridyl)-3-methyl-7-(pyridin-2-ylmethyl)-3,7-diaza-bicyclo[3.3.1]nonan-9-one-1,5-dicarboxylate, dimethyl 2,4-di-(2-pyridyl)-3-methyl-7-(N,N-dimethyl-amino-ethyl)-3,7-diaza-bicyclo[3.3.1]nonan-9-one-1,5-dicarboxylate, 5,12-dimethyl-1,5,8,12-tetraaza-bicyclo[6.6.2]hexadecane, 5,12-dibenzyl-1,5,8,12-tetraaza-bicyclo[6.6.2]hexadecane, N,N-bis(pyridin-2-yl-methyl-1,1-bis(pyridin-2-yl)-1-aminoethane, and N,N-bis(pyridin-2-yl-methyl-1,1-bis(pyridin-2-yl)-2-phenyl-1-aminoethane.

### Other Ligands

Other polydentate accelerant ligands known to those in the art may also be used, and these are discussed below. Typically these ligands may be used in pre-formed transition metal complexes, which comprise the polydentate accelerant ligand.

Firstly the polydentate accelerant ligand may be a bidentate nitrogen donor ligand, such as 2,2′-bipyridine or 1,10-phenanthroline, both of which are used known in the art as polydentate accelerant ligands in siccative metal driers. Often 2,2′-bipyridine or 1,10-phenanthroline are provided as ligands in manganese- or iron-containing complexes. Other bidentate polydentate accelerant ligands include bidentate amine-containing ligands. 2-aminomethylpyridine, ethylenediamine, tetramethylethylene-diamine, diaminopropane, and 1,2-diaminocyclohexane.

A variety of bi- to hexadentate oxygen donor-containing ligands, including mixed oxygen- and nitrogen-containing donor ligands, are also known. For example, WO 03/029371 A1 describes tetradentate diimines of the formula:

R₁—C(A₁-O)═N—R₂—N═C(A₂-O)—R₃

wherein:
A₁ and A₂ both are aromatic residues;
R₁ and R₃ are covalently bonded groups, for example hydrogen or an organic group; and
R₂ is a divalent organic radical.

The use of 1,3-diketones as polydentate accelerant ligands is described in both EP 1382648 A1 and WO 00/11090 A1, EP 1 382 648 also describing the use of complexes comprising 1,3-diketones (or 1,3-diimines) and bidentate diamines, including bipyridine and phenanthroline.

As used in this application, BOC is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) illustrated below.

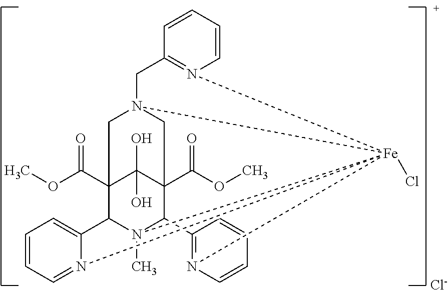

As used in this application, the term “secondary driers”, synonymously “auxiliary driers” means Calcium-Hydrochem (based on Calcium neodecanoate in organic solvents, Borchers), and Octa Soligen Zirconium 10 aqua (Zr-2-ethylhexanoate in organic solvents, Borchers) and other secondary driers having similar characteristics to the named above. Additionally, one or more auxiliary driers may be added to the fully formulated oxidatively curable coating composition. Such auxiliary driers may be optional additional components within, but are often not present in, the formulation of the invention. Such auxiliary driers include fatty acid soaps of zirconium, bismuth, barium, cerium, calcium, lithium, strontium, and zinc. Typically, fatty acid soaps are optionally substituted octanoates, hexanoates and naphthenates. Without being bound by theory, auxiliary driers (sometimes referred to as through driers) are generally understood to diminish the effect of adsorption of the main drier on solid particles often present in an oxidatively curable coating composition. Other non-metal based auxiliary driers may also be present if desired. Concentrations of auxiliary driers within oxidatively curable coating compositions (or formulations of the invention) are typically between about 0.01 wt. % and 2.5 wt. % as is known in the art.

A formulation of the invention can, and generally will, be used in the manufacture of a fully formulated oxidatively curable coating composition. By the term “fully formulated oxidatively curable coating composition” is implied, as is known to those of skill in the art, oxidatively curable formulations that comprise additional components over and above the binder (the oxidatively curable material, which is predominantly oxidatively curable alkyd resin according to the present invention), an aqueous or non-aqueous solvent/liquid continuous phase and any metal driers intended to accelerate the curing process. Such additional components are generally included to confer desirable properties upon the coating composition, such as color or other visual characteristics such as glossiness or mattness), physical, chemical and even biological stability (enhanced biological stability being conferred upon coating compositions by the use of biocides for example), or modified texture, plasticity, adhesion and viscosity.

For example, such optional additional components may be selected from solvents, antioxidants (sometimes referred to as antiskinning agents), additional siccatives, auxiliary driers, colorants (including inks and colored pigments), fillers, plasticizers, viscosity modifiers, UV light absorbers, stabilizers, antistatic agents, flame retardants, lubricants, emulsifiers (in particular where an oxidatively curable coating composition or formulation of the invention is aqueous-based), anti-foaming agents, viscosity modifiers, antifouling agents, biocides (e.g. bactericides, fungicides, algaecides and insecticides), anticorrosion agents, antireflective agents, anti-freezing agents, waxes and thickeners. Typically, formulations prepared in accordance with embodiments of the method of the second aspect of the invention will comprise at least an organic solvent, selected from the list of solvents described above, a filler and generally an antiskinning agent, in addition to the alkyd and optionally other binders and chelant present in the formulation of the invention. The skilled person is familiar with the incorporation of these and other components into oxidatively curable coating composition to optimize such compositions' properties.

It will be appreciated that some of these optional additional components possess more than one functional property. For example, some fillers may also function as colorants. The nature of any additional components and the amounts used may be determined in accordance with the knowledge of those of skill in the art and will depend on the application for which the curable coating compositions intended. Examples of optional additional components are discussed in the following paragraphs, which are intended to be illustrative, not limitative.

As used in this application, the term “Ambient conditions” refers to both temperature and humidity, i.e., to the conditions of the laboratory in contrast to climate-controlled conditions.

This invention gives air-drying paints containing vanadium compounds bearing anions of sulfonic acids as counter ions as well as application of these compounds in air-drying paints. These driers considerably accelerate drying and hardening of alkyd resins. They are suitable for solvent-borne as well as water-borne and high solid paints as well as for alkyd paints modified by other monomers. Furthermore, they can find utility in ink and composite coatings.

Driers, according to this invention, are compounds of formula (VII):

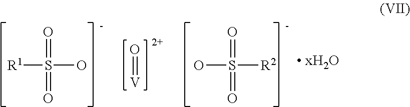

where R¹ and R² are independently selected from a group involving hydrogen, C₁-C₁₂ alkyl, C₁-C₈ fluorinated alkyl, C₆-C₁₀ aryl, benzyl; and whereas aryl and benzyl can be optionally substituted by one up to three substituents independently selected from a group involving C₁-C₂₀ alkyl, hydroxy(C₁-C₂)alkyl.

As used in this application, “Alkyl” can be linear or branched. Preferably, alkyl is C₁-C₁₂ alkyl, more preferably C₁-C₆ alkyl. A non-exhaustive list of examples of suitable alkyls are CH₃, C₂H₅, C₃H₇, C₄H₉, C₅H₁₁, C₆H₁₃, C₇H₁₅, C₈H₁₇, C₉H₁₉, C₁₀H₂₁, C₁₁H₂₃, and C₁₂H₂₅. In some embodiments, alkyl can be C₁₃-C₂₀ alkyl. The alkyl can be substituted with a halogen, particularly fluorine. Fluorinated alkyls can preferably be a linear fluorinated alkyl, non-limiting examples of which include: CF₃, C₂F₅, C₃F₇, C₄F₉, C₅F₁₁, C₆F₁₃, C₇F₁₅ and C₈F₁₇.

As used in this application, “Aryl” can be, for example, phenyl (C₆H₅) or naphthyl (C₁₀H₇). Substituted aryls can involve, for example, p-tolyl (CH₃C₆H₄), 1,4-dimethylphenyl ((CH₃)₂C₆H₃), 2,4,6-trimethylphenyl ((CH₃)₃C₆H₂), 4-ethylphenyl (C₂H₅C₆H₄), 4-isopropylphenyl (C₃H₇C₆H₄), 4-undecylphenyl (C₁₁H₂₃C₆H₄), 4-dodecylphenyl (C₁₂H₂₅C₆H₄), 4-tridecylphenyl (C₁₃H₂₇C₆H₄), 4-hexadecylphenyl (C₁₆H₃₃C₆H₄), 4-octadecylphenyl (C₁₈H₃₇C₆H₄), 4-methoxyphenyl ((OCH₃)C₆H₄).

As used in this application, “Benzyl” is substituent of formula CH₂C₆H₅.

The subject of the invention is paint formulation containing a binder curable by an autoxidation mechanism and at least one drier, an example of which is a vanadium compound of the formula I.

As used in this application, the formulation of cobalt 2-ethylhexanoate (“Co-2EH”) is as shown below:

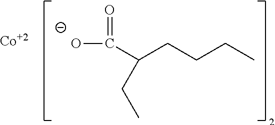

As used in this application, the formulation of vanadyl acetylacetonate (“V-acac”) is as shown below:

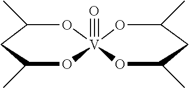

As used in this application, the formulation of “V—SO” is as illustrated below:

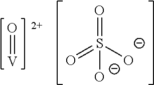

Binders, curable by an autoxidation mechanism, can be an alkyd resin or variations of alkyd resins, for example acrylic-modified alkyd resins, epoxy ester resins and resin modified by plant oils or fatty acids.

Preferably, the paint contains one or more driers of formula I in overall concentration at least 0.001 wt. %, preferably 0.003 to 0.3 wt. %, more preferably 0.006 to 0.3 wt. %, much more preferably 0.01 to 0.06 wt. %, of vanadium in dry material content of the paint.

The paint is prepared for example, by dissolution of the drier of formula I, subsequent treatment with air-drying binder and homogenization of the mixture. The catalyst can be added in any order to the paint formulation, or even as separate components using a vanadium source and a sulfonic acid source. Preferably, the drier is dissolved in polar organic solvent, e.g., dimethyl sulfoxide (DMSO), esters, ethers, solvents with more than one functional group of alcohols, esters, ethers (e.g., solvents such as texanol (2,2,4-trimethyl-1,3-pentanediolmonoisobutyrate (CAS Reg. No. 25265-77-4) and alcohols, or their mixture. Alternatively, the paint may be prepared by dissolving the drier in water. This is particularly useful when the binder is a water-borne resin.

By selection of the R¹ and R² groups in formula (VII), the drier can be dissolved in any organic solvent. It has been discovered that preparing driers of formula (VII) can be unstable in water-based formulations, tending to degrade or precipitate when diluted in water. This makes them unsuitable for many applications. This issue has been resolved by using a water-miscible solvent mixture, such as an alcohol-ester solvent mixture, for example combining 2-methyl-1-pentanol and isobutylacetate, as well as a carboxylic acid, such as acetic acid. It is believed that the acid provides an essential function in the stabilization of the catalyst, as it is well known that vanadate oligomerization—which may lead to deactivation of the drier—is sensitive to pH and concentration (see J. J. Cruywagen, in Advances in Inorganic Chemistry, Vol. 49 (Ed.: A. G. Sykes), Academic Press, 1999, pp. 127-182). The solvent mixture improves the long-term stability of the complex and its incorporation into the paint.

Depending on the application, the driers based on formula (VII) can be dissolved in water or polar organic solvents, e.g. dimethyl sulfoxide (DMSO), acetic acid, alcohols, esters, ethers and their mixtures.

It was found that driers of formula (VII), wherein R¹ and R² contain the same or different C₁₀-C₂₀ alkyl chains (e.g., 4-dodecylphenyl), are viscous liquids miscible with aromatic hydrocarbon solvents, e.g., toluene and xylene. This makes handling of the drier practical even for industrial use as only solvents commonly used in the paint-producing industry are required. This is particularly useful when the binder is a solvent-borne or high-solid resin.

Alternatively, the paint may be prepared by dissolving the drier directly in an air-drying binder. This is particularly useful when the drier is a compound of formula (VII) wherein R¹ and R² contain the same or different C₁₀-C₂₀ alkyl chains (e.g., 4-dodecylphenyl).

Subject of the invention is the use of vanadium compound of formula (VII) as drier for paints containing a binder curable by autoxidation mechanism.

It was found that driers of formula (VII) are active in concentration range 0.001-0.1 wt. % of metal on resin solids of the air-drying paint.

One of the main advantages of the driers of formula (VII), according to the invention, compared to currently known vanadium-based driers, is their simple one-step synthesis from readily available and inexpensive raw material. Compounds of formula I are easily modified through replacement of substituents R¹ and R², which enables to ensure satisfactory solubility in organic solvents used for paint production. Furthermore, formula (VII) based compounds can be easily dissolved in readily available and non-toxic solvent water in addition to additional solvents and a carboxylic acid to ensure stability and efficacy. Driers of formula (VII) are often of blue or green color.

A further advantage of the driers of formula (VII) is that stock solutions of the driers of formula (VII) can be stored under an atmosphere of air without loss of catalytic activity. This makes the handling of the stock solutions practical even for industrial use, as no inert atmosphere and/or oxygen-free conditions are required.

Further advantages of, compared to currently known vanadium-based driers, are improved stability toward air-oxygen and ability to cure wider range of alkyd-based paints. Compounds of formula I exhibit catalytic activity at considerably lower concentrations than currently widespread used cobalt-based driers. Surprisingly, it has been observed that driers of formula (VII) can give improved hardness when compared to cobalt and bispidon-based catalysts such as Borchi® OxyCoat. In addition, it has also been noted that preferable combinations with additional catalysts and amine-based ligands, to help improve hardness further.

Another advantage is the relative toxicity, products of formula (VII) are expected to produce non-toxic replacements for existing vanadium catalysts such as vanadyl acetylacetonate.

Driers of formula (VII) can be prepared by reaction of vanadium(V) oxide with appropriate sulfonic acid or mixtures of sulfonic acids (R¹SO₃H, R²SO₃H, where R¹ and R² can be the same of different) in mixture water-ethanol in ratio 1:2 by volume.

Compounds of type given in formula (VII) were previously synthesized by several methods. Reaction of oxidovanadium sulfate with barium salt of appropriate sulfonic acid was used for preparation of oxidovanadium trifluoromethanesulfonate (Krakowiak; Inorg. Chem. 51, 9598-9609 (2012)) and oxidovanadium p-toluenesulfonate (Movius, W. G. Et al; J. Am. Chem. Soc. 92, 2677-2683, (1970)).

Another literature procedure utilizes solvolysis of oxidovanadium acetylacetonate with p-toluenesulfonic acid (Holmes, S. M. et al; Inorg. Synth. 33, 91-103, (2002)). Anhydrous oxidovanadium methanesulfonate can be prepared by reaction of oxidovanadium(V) chloride with methanesulfonic acid in chlorobenzene, or by direct solvolysis of oxidovanadium(IV) chloride with methanesulfonic acid (Kumar, S. et al; Indian J. Chem. 23A, 200-203, (1984)). Procedure, given in this invention, uses vanadium(V) oxide (CAS: 1314-62-1) as a source of vanadium, which is considerably beneficial from economical point of view, when compared to aforementioned raw materials. Ammonium metavanadate can be used as another economic source of vanadium for the preparation of compounds.

The present invention further includes the compound oxidovanadium p-dodecylbenzenesulfonate, which corresponds to formula (VII) wherein R¹ and R² are dodecylphenyl. This compound represents a novel compound prepared within the framework of the present invention.

### EXAMPLES OF THE INVENTION

Alkyd resin CHS-Alkyd S 471×60 (oil length=47%, acid number 6 mg KOH/g), S471, CHS-Alkyd TI 870 (oil length=87%, acid number 8 mg KOH/g), TI870, were obtained Spolchemie a.s. Alkyd resins NEBORES® SPS 15-60 D (oil length=50%, acid number 10 mg KOH/g, silicone content=30%), SPS15, was obtained from Safic-Alcan Cesko, s.r.o.

Vanadium(V) oxide, methanesulfonic acid, p-toluenesulfonic acid monohydrate, oxidovanadium sulfate hydrate (V—SO), 2-methyl-1-pentanol and dimethyl sulfoxide (DMSO) were obtained from Acros-Organics. Cobalt 2-ethylhexanoate (Co-2EH) was obtained from Sigma-Aldrich. Acetic acid was obtained from Riedel-de-Haen. Isobutylacetate was obtained by Alfa Aesar.

Borchi Oxy-Coat 1101 (BOC 1101, in water), Borchi Oxy-Coat (BOC, in propylene glycol), Borchers Deca Cobalt 7 aqua (in organic solvent mixture), Borchers Deca Cobalt 10 (in hydrocarbon solvents) and N,N,N-Trimethyl-1,4,7-triazacyclononane (TMTACN) were obtained from Borchers.

The binder solutions SYNAQUA 4804 (water-borne short oil alkyd) and SYNAQUA 2070 (water-borne medium oil alkyd) were obtained from Arkema; Beckosol AQ101 (water-borne long oil alkyd) from Polyont Composites USA Inc., WorleeKyd S 351 (solvent-borne medium oil alkyd) from Worlee and TOD 3AK0211Y (water-reducible alkyd) from TOD China.

### Example 1—Synthesis of Oxidovanadium Methanesulfonate, (“V-MS”)

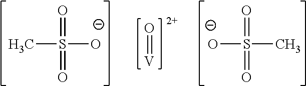

A suspension of vanadium(V) oxide (5.6 g) in mixture with ethanol (30 mL) and distilled water (15 ml) was treated with methanesulfonic acid (16 mL) and heated at 110° C. for 3 h. Appearing dark blue, the solution was filtered and volatiles were evaporated. The product was washed with diethyl ether and vacuum dried to reach a blue solid. Yield: 15.9 g. Elemental analysis (C₂H₁₆O₁₂S₂V): Calculated: C, 6.92; H, 4.64; S, 18.47. Found: C, 6.78; H, 4.81; S, 18.11. EPR (H2O): |Aiso|=116.4×10-4 T; giso=1.966.

### Example 2—Synthesis of Oxidovanadium Trifluoromethanesulfonate, V—FS

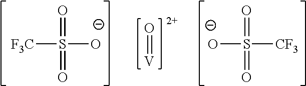

A suspension of vanadium(V) oxide (5.6 g) in a mixture of ethanol (30 mL) and distilled water (15 mL) was treated with trifluoromethanesulfonic acid (22 mL) and heated at 110° C. for 6 h. Appearing green-blue, the solution was filtered and volatiles were evaporated. The product was washed with diethyl ether and vacuum dried to reach a green-blue solid. Yield: 21.8 g. Elemental analysis (C₂H₁₀F₆O₁₂S₂V): Calculated: C, 5.28; H, 2.21; S, 14.09. Found: C, 5.37; H, 1.99; S, 14.22. EPR (H₂O): |Aiso|=116.4×10-4 T; giso=1.966.

### Example 3—Synthesis of Oxidovanadium Benzenesulfonate, V—BS

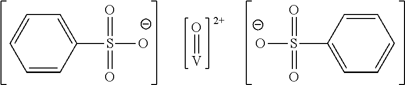

A suspension of vanadium(V) oxide (5.6 g) in a mixture of ethanol (30 mL) and distilled water (15 mL) was treated with benzenesulfonic acid (39 g) and heated at 110° C. for 3 h. Appearing dark blue, the solution was filtered and volatiles were evaporated. The product was washed with diethyl ether and vacuum dried to reach a blue solid. Yield: 27.5 g. Elemental analysis (C₁₂H₂₀O₁₂S₂V): Calculated: C, 30.58; H, 4.28; S, 13.61. Found: C, 30.72; H, 4.39; S, 13.80. EPR (H₂O): |Aiso|=116.4×10⁻⁴ T; giso=1.966.

### Example 4—Synthesis of Oxidovanadium p-Toluenesulfonate, (“V-TS”)

A suspension of vanadium(V) oxide (56 g) in mixture with ethanol (300 mL) and distilled water (150 ml) was treated with p-toluenesulfonic acid monohydrate (700 g) and heated at 110° C. for 3 h. Appearing dark blue, the solution was filtered and volatiles were evaporated. The product was washed with diethyl ether and vacuum dried to reach a blue solid. Yield: 290 g. Elemental analysis (C₁₄H₂₄O₁₂S₂V): Calculated: C, 33.67; H, 4.84; S, 12.84. Found: C, 33.48; H, 4.96; S, 12.51. EPR (H2O): |Aiso|=116.4×10-4 T; giso=1.966.

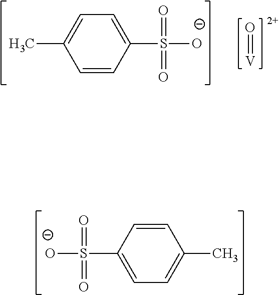

### Example 5—Synthesis of Oxidovanadium p-Dodecylbenzenesulfonate, V-DS

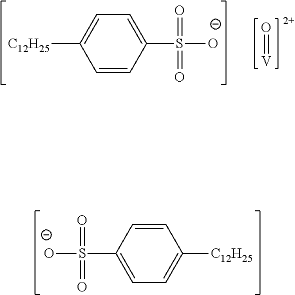

A suspension of vanadium(V) oxide (5.6 g) in a mixture of ethanol (30 mL) and distilled water (15 mL) was treated with p-dodecylbenzenesulfonic acid (48 g) and heated at 110° C. for 6 h. Appearing dark blue, the solution was filtered and volatiles were evaporated. The product was washed with hexane at −20° C. and vacuum dried to reach a blue highly viscous liquid miscible with aromatic hydrocarbon solvents (e.g. toluene, xylene). Yield: 44.3 g. Elemental analysis (C₃₆H₆₈O₁₂S₂V): Calculated: C, 53.51; H, 8.48; S, 7.94. Found: C, 53.85; H, 8.84; S, 7.67. EPR (acetone): |Aiso|=117.3×10⁻⁴ T; giso=1.966.

### Example 6—Effect of Substituents on Curing of Solvent-Borne Alkyd Resins

The catalytic activity of the oxidovanadium sulfonates was determined on alkyd resin of medium oil-length modified by vegetable drying oil S471. The effect of substituents was studied in five derivatives. Given driers were dissolved on DMSO (100 μL) and treated by alkyd resin S471 (5 g) and appearing mixture was homogenized for 2 min. The formulations were cast on glass plates (dimensions: 305×25×2 mm) by a frame applicator of 76 μm gap. Determination of set-to-touch time (T₁), tack-free time (T₂), dry-hard time (T₃) and dry-through time (T₄) was done on B. K. Drying Recorder (BYK) in accordance with ČSN EN ISO 9117-4. Determination of relative hardness was done on formulations casted on glass plates (dimensions: 200×100×4 mm) by a frame applicator of 150 μm gap. Relative hardness was determined 100 days after application using Pendulum Hardness Tester (Elcometer) with Persoz-type pendulum in accordance with ČSN EN ISO 1522. Determination of drying times and relative hardness was done under standard laboratory conditions (t=23° C., relative humidity=50±10%). Formulations of V-acac and V—SO were prepared in a similar way. Co-2EH was used as obtained from supplier.

Drying times, given in Table I, show a high catalytic activity of oxidovanadium sulfonates in the range of concentrations 0.01 to 0.06 wt. % of vanadium in dry mater content. All derivatives under the study give fully dried films within 13.0 hours (T₄≤13.0 h) at this range of concentrations. At optimal dosage (0.03 wt. %), the dries give a film with hard surface within 3.4 hours (T₃≤3.4 h) and fully dried film within 5.3 hours (T₄≤5.3 h). V-TS stays highly active up to concentration 0.003 wt. %. At this dosage, fully dried film was observed 14.1 hours after casting. It is noteworthy that drying activity of V-TS was observed even at very low concentrations. At 0.001 wt. %, the tack free time does not exceed 12.9 hours (T₂=12.9 h). We note that V-TS was chosen for studies on the other binders, due to observed catalytic activity at very low concentrations.

The relative hardness of the films cured by oxidovanadium sulfonates, measured 100 days after casting of the formulations, varied between 32.6% and 52.8%.

A comparison of the drying times with cobalt-based drier (Co-2EH) proves that V-MS, V—FS, V—BS, V-TS and V-DS perform at considerably lower concentrations than this commercial drier. Vanadium-based drier V-acac shows a lower activity at concentration 0.03 wt. % than all oxidovanadium sulfonates under the study. The structural analogue of here presented compounds bearing sulfate anion (V—SO) is fully inactive.

Drying times, given in Table I, show a high catalytic activity of vanadium compounds containing sulfonate anions in the range of concentrations 0.006 to 0.06 wt. % of vanadium in dry material content. Both derivatives (V-MS and V-TS) give fully dried films within 13.9 hours (T4≤13.9 h) at this range of concentrations. At optimal dosage, the derivative bearing aliphatic group (V-MS; 0.03 wt. %) gives a film with hard surface within 3.4 hours (T3=3.4 h) and fully dried film within 4.4 hours (T4=4.4 h).

At optimal concentration (0.03 wt. %), the use of the drier bearing the aromatic ring (V-TS) leads to film with hard surface within 1.2 hours (T₃=1.2 h) and fully dried film already after 2.4 h (T4=2.4 h). It is noteworthy that drying activity was observed already at a very low concentration (0.001 wt. %). In this case, the tack free time does not exceed 12.9 hours (T₂=12.9 h).

The relative hardness of the films, measured 100 after casting of the formulations, vary between 43.0 and 52.8%. V-TS was chosen for studies on the other binders due to observed catalytic activity at very low concentration (0.003 wt. %). It gives a fully dried film within 14.1 h.

A comparison of the drying times with cobalt-based drier (Co-2EH) proves that V-MS and V-TS perform at considerably lower concentrations than the commercial drier. Vanadium-based drier V-acac shows lower activity at concentration 0.03 wt. % than both V-MS and V-TS. The structural analogue of the presented compounds bearing the sulfate anion (V—SO) is fully inactive.

TABLE I
Drying times and relative hardness of alkyd
films consisting of S471 and given drier

| | | | | | Rel. |
|---|---|---|---|---|---|
| | Metal conc. in | | | | hardness |
| Drier | dry matl. (wt. %) | T₂ (h) | T₃ (h) | T₄ (h) | (%) |
| V-MS | 0.06 | 0.2 | 3.1 | 3.1 | 48.0 |
| | 0.03 | 0.4 | 3.4 | 4.4 | 46.3 |
| | 0.01 | 0.9 | 6.6 | 7.4 | 43.9 |
| | 0.006 | 1.6 | 9.7 | 13.9 | 43.8 |
| | 0.003 | 5.9 | >24 | >24 | 43.0 |
| | 0.001 | >24 | >24 | >24 | 43.0 |
| V-FS | 0.06 | 0.2 | 2.3 | 6.0 | 48.9 |
| | 0.03 | 0.4 | 2.5 | 5.3 | 47.1 |
| | 0.01 | 0.8 | 5.9 | 9.7 | 44.9 |
| | 0.006 | 3.9 | 16.3 | >24 | 41.6 |
| V-BS | 0.06 | 0.1 | 1.5 | 3.9 | 51.9 |
| | 0.03 | 0.1 | 1.5 | 2.5 | 49.3 |
| | 0.01 | 0.2 | 3.9 | 3.9 | 45.3 |
| | 0.006 | 0.5 | 6.0 | 7.2 | 44.9 |
| | 0.003 | 2.1 | 11.9 | >24 | 44.3 |
| | 0.001 | 9.5 | >24 | >24 | 44.6 |
| V-TS | 0.06 | 0.2 | 2.8 | 9.3 | 52.8 |
| | 0.03 | 0.2 | 1.2 | 2.4 | 51.9 |
| | 0.01 | 0.4 | 2.9 | 4.1 | 45.4 |
| | 0.006 | 0.9 | 4.5 | 4.9 | 45.3 |
| | 0.003 | 1.6 | 8.3 | 14.1 | 45.1 |
| | 0.001 | 12.9 | >24 | >24 | 43.3 |
| V-DS | 0.06 | —^{a} | 1.1 | 7.9 | 40.5 |
| | 0.03 | —^{a} | 0.9 | 3.2 | 38.3 |
| | 0.01 | 0.4 | 4.4 | 13.0 | 34.6 |
| | 0.006 | 0.7 | 4.6 | 17.0 | 34.1 |
| | 0.003 | 0.8 | 13.1 | >24 h | 32.6 |
| | 0.001 | 7.6 | >24 h | >24 h | —^{b} |
| Co-2EH | 0.1 | 0.4 | 6.5 | 11.3 | 47.3 |
| | 0.06 | 2.1 | 4.5 | 19.6 | 48.9 |
| | 0.03 | 8.6 | 11.5 | 21.7 | 45.0 |
| | 0.01 | 18.0 | >24 | >24 | 42.2 |
| | 0.005 | >24 | >24 | >24 | —^{b} |
| V-acac | 0.03 | 1.3 | 6.7 | 6.7 | 45.3 |
| V-SO | 0.06 | >24 | >24 | >24 | —^{b} |
| without drier | — | >24 | >24 | >24 | —^{b} |

^{a}formulation was set-to-touch dried immediately after casting,
^{b}not measured due to a low surface drying or surface defects.

### Example 7—Curing of High-Solid Alkyd Resin

The evaluation of the catalytic effect in high-solid binders was done with the drier V-TS and high-solid binder TI870. Drier was dissolved in DMSO (100 μL) and treated by given alkyd resin (5 g). The mixture was diluted by dearomatized white spirit to reach dry material of 90 wt. % and homogenized for 2 min. Determination of drying times was done on formulations casted on glass plates by frame applicator of 76 μm gap. Frame applicator of 90 μm gap was used for application of formulations on plates intended for determination of relative hardness. Formulations Co-2EH, V-acac a V—SO were prepared in a similar way.

Measured drying times and values of relative hardness are given in Table II. Formulations V-TS/TI870 exhibit catalytic activity in the range 0.01 to 0.1 wt. % of vanadium in dry mater content. Optimal concentration of the drier was determined to be 0.06 wt. % for this high-solid binder. Relative hardness of films, measured 100 days after casting of the formulation, vary between 17.1% and 24.9%.

Formulations V-TS/TRI841 exhibit catalytic activity in the range 0.01 to 0.1 wt. % of vanadium in dry material content. Optimal concentration of the drier was determined to be 0.03 wt. % for this high-solid binder. The relative hardness of the films, measured 100 days after casting of the formulation, vary between 15.5 and 21.5%.

A comparison of the drying times with cobalt-based drier Co-2EH is evident that formulations containing V-TS are better through dried. Indeed, formulations treated with Co-2EH are not fully dried within 24 hours (T4>24 h) while formulations of V-TS are through dried within 11.5 hours (T₄≤11.5 h). Vanadium compounds V-acac and V—SO are not active at concentration 0.06 wt. % in the binders TI870 and TRI841.

TABLE II
Drying times and relative hardness of alkyd paints of TI870

| | Metal conc. | | | | | Rel. |
|---|---|---|---|---|---|---|
| | In dry mater | | | | | Hardness |
| Drier | (wt. %) | T₁(h) | T₂(h) | T₃(h) | T₄(h) | (%) |
| V-TS | 0.1 | 1.3 | 1.8 | 2.2 | 2.2 | 24.9 |
| | 0.06 | 1.9 | 2.5 | 3.4 | 3.4 | 21.3 |
| | 0.03 | 2.5 | 3.6 | 45 | 4.5 | 19.7 |
| | 0.01 | 4.9 | 6.9 | 9.4 | 9.4 | 17.1 |
| Co-2EH | 0.06 | 1.0 | 6.6 | >24 | >24 | 27.4 |
| | 0.03 | 1.7 | 5.4 | 12.9 | >24 | 22.8 |
| | 0.01 | 4.1 | 8.0 | 9.6 | >24 | 18.1 |
| V-acac | 0.06 | >24 | >24 | >24 | >24 | — ^{a} |
| V-SO | 0.06 | >24 | >24 | >24 | >24 | — ^{a} |
| without drier | — | >24 | >24 | >24 | >24 | — ^{a} |

^{a} not measured due to a low surface drying or surface defects

TABLE III
Drying times and relative hardness of alkyd
films consisting of TRI841 and given drier

| | Metal conc. | | | | | Rel. |
|---|---|---|---|---|---|---|
| | in dry matl. | | | | | hardness |
| Drier | (wt. %) | T₁ (h) | T₂ (h) | T₃ (h) | T₄ (h) | (%) |
| V-TS | 0.1 | 1.7 | 2.7 | 3.3 | 8.2 | 21.5 |
| | 0.06 | 2.2 | 2.9 | 3.5 | 4.5 | 20.4 |
| | 0.03 | 2.7 | 4.5 | 3.5 | 3.5 | 18.7 |
| | 0.01 | 5.2 | 6.5 | 11.5 | 11.5 | 15.5 |
| Co-2EH | 0.06 | 0.9 | 4.9 | 14.0 | >24 | 23.5 |
| | 0.03 | 1.6 | 5.4 | 10.9 | >24 | 19.1 |
| | 0.01 | 4.1 | 5.6 | 10.4 | >24 | 14.6 |
| V-acac | 0.03 | >24 | >24 | >24 | >24 | —^{a} |
| V-SO | 0.06 | >24 | >24 | >24 | >24 | —^{a} |
| without drier | — | >24 | >24 | >24 | >24 | —^{a} |

^{a}not measured due to a low surface drying or surface defects.

### Example 8—Curing of Alkyd Resin Modified by Another Monomer

Evaluation of the catalytic effect in siliconized alkyd binders was done with the drier V-TS and resin SPS15. The drier was dissolved in DMSO (100 μL) and treated by given alkyd resin (5 g) and homogenized for 2 min. Determination of drying times was done on formulations casted on glass plates by frame applicator of 76 μm gap. Frame applicator of 150 μm gap was used for application of formulations on plates intended for determination of relative hardness. Formulations Co-2EH, V-acac a V—SO were prepared in similar way.

Measured drying times and values of relative hardness are given in Table IV. Formulations V-TS/SPS15 exhibit catalytic activity in the range 0.003 to 0.06 wt. % of vanadium in dry mater content. Optimal concentration of the drier was determined to be 0.03 wt. % for this siliconized binder, which is comparable to solvent-borne alkyd binder of medium oil length S471. Relative hardness of films, measured 100 days after casting of the formulation, vary between 32.8% and 46.2%.

Comparison of the drying times with cobalt-based drier Co-2EH is evident that V-TS is catalytically active at much lower concentrations than the commercial cobalt drier. Vanadium compounds V-acac and V—SO are not active at concentration 0.06 wt. %.

TABLE IV
Drying times and relative hardness of alkyd paints of SPS15

| | Metal conc. | | | | | Relative |
|---|---|---|---|---|---|---|
| | in dry material | | | | | Hardness |
| Drier | (wt. %) | T₁(h) | T₂(h) | T₃(h) | T₄(h) | (%) |
| V-TS | 0.06 | — ^{a} | 0.2 | 0.9 | 1.5 | 46.2 |
| | 0.03 | — ^{a} | 0.7 | 1.8 | 4.1 | 42.7 |
| | 0.01 | — ^{a} | 1.4 | 3.9 | 6.6 | 35.8 |
| | 0.006 | — ^{a} | 2.9 | 11.4 | 14.2 | 34.1 |
| | 0.003 | — ^{a} | 6.5 | 14.9 | 17.0 | 32.8 |
| | 0.001 | — ^{a} | >24 | >24 | >24 | — ^{b} |
| Co-2EH | 0.1 | 0.4 | 7.8 | 10.7 | 12.2 | 41.2 |
| | 0.06 | 0.4 | 13.2 | 15.7 | 17.0 | 39.2 |
| | 0.03 | 0.6 | >24 | >24 | >24 | — ^{b} |
| | 0.01 | 0.2 | >24 | >24 | >24 | — ^{b} |
| | 0.005 | 0.3 | >24 | >24 | >24 | — ^{b} |
| V-acac | 0.03 | >24 | >24 | >24 | >24 | — ^{b} |
| V-SO | 0.06 | >24 | >24 | >24 | >24 | — ^{b} |
| without | — | >24 | >24 | >24 | >24 | — ^{b} |
| drier | | | | | | |

^{a} formulation was set-to-touch dried immediately after casting
^{b} not measured due to a low drying or surface defects

### Example 9—Curing of Water-Borne Alkyd Resin and Full Paint Formulation

The evaluation of the catalytic effect in water-borne systems was done with the drier V-TS in alkyd resin FP262 and commercial white pigmented paint MLP 9289, which is based on the resin FP262. V-TS (1 g) was dissolved in distilled water (2 g) to give a stock solution, which was used for preparation of formulations. The determination of drying times was done on formulations casted on glass plates by a frame applicator of 76 μm gap. Formulation of V—SO was prepared in a similar way. V-acac was predissolved in DMSO before use. Co-2EH was used as obtained from supplier.

Measured drying times for formulations FP262 and MLP 9289 are given in Table V and Table VI, respectively.

Formulations V-TS/FP262 exhibit a high catalytic activity in the range of 0.03 to 0.06 wt. % of vanadium in dry mater content. At this dosage, tack-free time (T₂) varies between 2.0 and 5.6 hours; dry hard time (T₃) varies between 6.0 and 11.7 hours. The optimal concentration of the drier was determined to be 0.06 wt. % for the water-borne resin FP262. Curing of FP262 by the action of cobalt-based drier Co-2EH was faster but considerably less homogenous. It is evidenced by the increase of T₃ with increasing concentration.

Full alkyd paint V-TS/MLP 9289 exhibit a high catalytic activity in the range of 0.03 to 0.06 wt. % of vanadium in dry mater of the resin. Optimal concentration of the drier was determined to be 0.06 wt. % for MLP 9289, which is comparable to binder FP262. It proves a minor effect of the pigment and other additives on the catalytic activity of the drier V-TS.

Vanadium compounds V-acac and V—SO are not active at concentration 0.06 wt. %. It is noted that no water-borne system, under the study, was through dried within 24 hours.

TABLE V
Drying times of alkyd films consisting of FP262 and given drier

| | Metal conc. in | | | |
|---|---|---|---|---|
| Drier | dry material (wt. %) | T₂ (h) | T₃ (h) | T₄ (h) |
| V-TS | 0.06 | 2.0 | 6.0 | >24 |
| | 0.03 | 2.6 | 8.0 | >24 |
| | 0.01 | 5.6 | 11.7 | >24 |
| Co-2EH | 0.1 | 0.5 | 8.8 | >24 |
| | 0.06 | 0.7 | 6.5 | >24 |
| | 0.03 | 1.2 | 4.8 | >24 |
| V-acac | 0.06 | >24 | >24 | >24 |
| V-SO | 0.06 | >24 | >24 | >24 |
| without drier | — | >24 | >24 | >24 |

TABLE VI
Drying times of alkyd films consisting
of MLP 9289 and given drier

| | Metal conc. in | | | |
|---|---|---|---|---|
| Drier | dry material of resin (wt. %) | T₂ (h) | T₃ (h) | T₄ (h) |
| V-TS | 0.06 | 3.0 | 6.4 | >24 |
| | 0.03 | 5.0 | 9.4 | >24 |
| | 0.01 | 12.7 | >24 | >24 |
| Co-2EH | 0.1 | 1.4 | 5.8 | >24 |
| | 0.06 | 2.3 | 4.0 | >24 |
| | 0.03 | 3.7 | 6.8 | >24 |
| V-acac | 0.06 | >24 | >24 | >24 |
| V-SO | 0.06 | >24 | >24 | >24 |
| without drier | — | >24 | >24 | >24 |

### Example 10—Stability of the Oxidovanadium Sulfonates in Solution

An evaluation of the stability in solution was done for the driers V-TS and V-DS. V-TS (1 g) was dissolved in DMSO (4 g) and a blue solution was obtained and stored under air atmosphere at room temperature in a closed glass vial (10 mL). A determination of drying times was done on formulations of solvent-borne alkyd resin S471 casted on glass plates by a frame applicator of 76 μm gap and compared with a freshly prepared solution of V-TS. The stability of V-DS was evaluated in a similar way using solutions prepared from V-DS (1 g) and xylene (1 g). It was noted that the stock solutions showed no visual changes upon storage.

Measured drying times are given in Table VII. The solution of V-TS in DMSO exhibits only minor changes of the catalytic activity within 30 days of storage, as evidenced on the formulations S471 in the concentration range 0.01 to 0.03 wt. % of vanadium in dry material content. All formulations of V-TS, under the study, are fully dried within 5.2 hours (T₄≤5.2 h). Acceptable decrease of catalytic activity is observed also for solution of V-DS in xylene. In the concentration range 0.01 to 0.03 wt. %, the storage for 9 days prolongs curing process of the xylene solutions. Dry-through times (T₄) are approximately twice of values observed for fresh solutions.

TABLE VII
Drying times of alkyd films consisting of S471 and given drier

| | | Metal conc. in | | | |
|---|---|---|---|---|---|
| Drier | Solvent | dry material (wt. %) | T₂ (h) | T₃ (h) | T₄ (h) |
| V-TS | DMSO | 0.03 | 0.1 | 1.0 | 1.5 |
| fresh | DMSO | 0.01 | 0.5 | 2.3 | 3.4 |
| V-TS | DMSO | 0.03 | 0.1 | 0.7 | 1.0 |
| stored | DMSO | 0.01 | 0.3 | 2.3 | 4.7 |
| (9 days) | | | | | |
| V-TS | DMSO | 0.03 | 0.3 | 0.9 | 1.5 |
| stored | DMSO | 0.01 | 0.7 | 2.5 | 5.2 |
| (30 days) | | | | | |
| V-DS | Xylene | 0.03 | 0.2 | 0.3 | 2.8 |
| fresh | Xylene | 0.01 | 0.3 | 0.9 | 3.3 |
| V-DS | Xylene | 0.03 | 0.1 | 1.0 | 4.9 |
| stored | Xylene | 0.01 | 0.3 | 1.5 | 7.8 |
| (9 days) | | | | | |

### Example 11—Stability of Paint Formulation

The stability of V-TS in paint formulations was evaluated on alkyd resin S471 treated with an antiskinning agent. A solution of V-TS in DMSO (1:4 mixture by weight) was treated by alkyd resin S471 (25 g) and butanone oxime (30 mg). The formulations were dosed into glass vials (5 mL) and stored at room temperature. Determination of drying times was done on formulations casted on glass plates by a frame applicator of 76 μm gap.

Measured drying times are given in Table VIII and negligible changes of the catalytic activity upon storage were noted for V-TS at metal concentration 0.03 wt. %, as the stored formulations are fully dried within 2.1 hours (T₄=1.1 to 2.1 h) while fresh formulations is dried within 1.7 h (T₄=1.7 h). At lower dosage (0.01 wt. %), the minor decrease of the activity is observed within 7 days, as documented by prolongation of T₄ from 7.1 h to 12.8 h. After this period, the formulations are stable as only negligible changes of drying times are observed.

TABLE VIII
Drying times of alkyd films consisting of S471/MEKO/V-TS

| | Metal conc. in | | | |
|---|---|---|---|---|
| Formulation | dry material (wt. %) | T₂ (h) | T₃ (h) | T₄ (h) |
| Fresh | 0.03 | 0.5 | 1.0 | 1.7 |
| | 0.01 | 2.5 | 5.2 | 7.1 |
| Stored for | 0.03 | 0.2 | 0.5 | 1.9 |
| 7 days | 0.01 | 2.1 | 5.3 | 12.8 |
| Stored for | 0.03 | 0.3 | 1.5 | 2.1 |
| 14 days | 0.01 | 2.3 | 6.8 | 12.7 |
| Stored for | 0.03 | 0.2 | 0.7 | 1.1 |
| 21 days | 0.01 | 2.8 | 8.4 | 11.3 |

### Experimental Details for Examples #12 to #18

V-TS was used as an aqueous solution in most cases which must be prepared freshly on the day of employment, as it forms significant amounts of precipitate after standing for several hours (usually >12-24 h). V-TS can also be dissolved in polar organic solvents without formation of precipitate, but limited experience has been gained with these solutions.

Freshly prepared aqueous solutions of V-TS were found to directly develop large amounts of precipitate if a base was added (ethanolamine). However, a stable solution over more than two weeks resulted when V-TS (10%) was dissolved in a solution of 98:2 water:acetic acid.

Oxidovanadium p-dodecylbenzenesulfonate, (“V-DS”) can be dissolved in most organic solvents and these solutions appeared to be stable. For applications in SB formulations, a solution in xylene was used. For applications in WB formulations, a 70:30 mixture of 2-methyl-1-pentanol and isobutylacetate was used.

The formulation to be used for casting a film were prepared by weighing an appropriate amount of drier, usually a stock solution of defined concentration, into a plastic vial, followed by the binder solution. The amount of drier was calculated referring to the value of dry material as specified for each binder solution. Mixing was achieved by placing the vial into a speed mixer (SpeedMixer DAC 150.1 FVZ) and rotating it with 2000 rounds per minute for two minutes. Generally, a homogeneous-looking mixture was received. This was left under ambient conditions for 24 hours before films were cast.

“B.K. drying recorders model 3” (The Mickle laboratory engineering Co Ltd.) dry time recorder were used to measure the time required to reach the drying states of set-to-touch (ST, i.e. no longer moving freely through the soft coating but starting to rip the hardening film), tack-free (TF, i.e. no longer ripping the film but still leaving a continuous line on the coating) and dry-hard (DH, i.e. not leaving any mark on the film).

A film of 100 μm thickness was cast on a glass strip (30×2.4 cm) by using a steel cube applicator. This is then placed on the dry time recorder, a needle was put on the film, the recorder was set for measurement over 24 hours and started. The starting point where the needle was put onto the film was marked on the glass. The drying time was read from the marks left on the film after 24 hours. Dry times given as “24 h” indicate dry times of 24 h, as times longer than 24 hours could not have been determined.

The coating of the glass strips and the recording of dry time was performed in a climate-controlled room with a temperature of 23° C. and a humidity of ca. 45%.

Films of 100 μm thickness were cast on glass sheets (15×9 cm) for measurement of hardness at the same time as when casting films for dry time recording. These were evaluated on a pendulum hardness tester after the drying times given. Pendulum hardness was measured on a TQC Sheen Pendulum Hardness Tester SP0500 by using the Konig method (measuring the time of oscillations in seconds, starting at an initial amplitude of 6° and until an amplitude of 3° is reached). Softer material dampens the pendulum's oscillations more quickly than harder material, so softer material has a lower hardness value in seconds than harder material. The coating of the glass plates, storage and measurement of hardness was performed in a climate-controlled room with a temperature of 23° C. and a humidity of ca. 45%.

Catalyst concentrations are given in metal %, referring to the catalyst's metal amount relative to the solid content of the binder and formulation, resp., which is employed. Generally, catalysts are employed in three concentrations, 0.001 metal %, 0.01 metal % and 0.1 metal % for initial testing. Standard concentrations used for BOC and Borchers Deca Cobalt 7 aqua are 0.001 and 0.03 metal %, resp., based on general recommendations for these driers.

### Example #12—Additional Formulas (See Tables IX to Table XI)

TABLE IX
11Ycc (TOD 3AK0211Y-based clear coat, water borne)

| | | | Amount |
|---|---|---|---|
| Entry | Ingredient | Type | (g) |
| 1 | TOD 3AK0211Y (72% solid) | Resin | 150.0 |
| 2 | Dimethylethanolamine | Amine | 3.3 |
| 3 | Ethylene glycol butyl ether | Solvent | 7.5 |
| 4 | deionized water | Solvent | 180.0 |
| 5 | NaNO2 20% aq. | Anti flash rust | 2.5 |
| 6 | Borchi Gol 1375, Borchers | Wetting agent | 0.3 |
| 7 | Borchi Gel 0620 (50%), Borchers | Rheology modifier | 0.6 |

TABLE X
11Ywp (TOD 3AK0211Y-based white paint, water borne)

| | | | Amount |
|---|---|---|---|
| Entry | Ingredient | Type | (g) |
| 1 | TOD 3AK0211Y-based clear coat | Resin formulation | 70.0 |
| 2 | deionized water | Solvent | 8.2 |
| 3 | Borchi Gen 1252, Borchers | Dispersing agent | 0.6 |
| 4 | Aminopropanol 95% | Amine | 0.1 |
| 5 | Borchers AF 1171, Borchers | Additive | 0.1 |
| 6 | R996 Titanium dioxide | Pigment | 21.0 |

TABLE XI
vSAcc (Synaqua 4804-based clear coat, water borne)

| | | | Amount |
|---|---|---|---|
| Entry | Ingredient | Type | (g) |
| 1 | Synaqua 4804 | Resin | 95.0 |
| 2 | Borchi Gel 0435 | Rheology modifier | 1.5 |
| 3 | DBE-5 | Additive | 3.5 |

### Example #13—Curing of a Water-Borne Resin

This example shows that a water-borne resin (Synaqua 4804 short oil) can be cured. Given driers are dissolved in water (V-TS) or in alcohol-ester mixtures (oxidovanadium p-toluenesulfonate, (“V-TS”)) to ensure homogeneity of the water-borne formulation, e.g. a mixture of 2-methyl-1-pentanol and isobutylacetate. The commercial driers BOC-1101 and Deca Cobalt 7 aqua were used as references, at their optimized dose levels as given in the technical data sheets.

Dry time and hardness measurements were performed as stated above in the section “Experimental details for Examples #12 to #18”.

TABLE XII

| | | | Dry times in h | | | Hardness in s, after | | |
|---|---|---|---|---|---|---|---|---|
| # | Drier | metal % | ST | TF | DH | 1 d | 7 d | 14 d |
| 1 | BOC-1101 | 0.001 | 0.5 | 17.8 | 24.0 | 24.3 | 30.8 | 36.5 |
| 2 | Deca Cobalt | 0.030 | 1.3 | 18.9 | 24.0 | 21.9 | 37.4 | 49.1 |
| | 7 aqua | | | | | | | |
| 4 | V-TS | 0.001 | 12.0 | 24.0 | 24.0 | 10.3 | 23.8 | 34.6 |
| 5 | V-TS | 0.010 | 3.0 | 8.1 | 19.8 | 27.1 | 35.0 | 34.1 |
| 6 | V-TS | 0.100 | 0.5 | 2.4 | 5.1 | 27.5 | 41.6 | 52.4 |
| 7 | V-DS | 0.001 | 3.5 | 24.0 | 24.0 | 6.5 | 22.9 | 29.5 |
| 8 | V-DS | 0.010 | 2.9 | 19.0 | 19.0 | 26.1 | 32.7 | 37.4 |
| 9 | V-DS | 0.100 | 0.3 | 3.3 | 5.4 | 28.9 | 39.2 | 47.7 |
| 11 | BOC-1101 + | 0.001 | 0.5 | 14.5 | 24.0 | 17.7 | 32.3 | 42.1 |
| | V-TS^{b} | | | | | | | |
| 12 | BOC-1101 + | 0.001 | 0.4 | 3.3 | 20.4 | 26.1 | 34.2 | 44.0 |
| | V-DS^{c} | | | | | | | |

^{b}with addition of 0.01 metal % V-TS;
^{c}with addition of 0.01 metal % V-DS.

The data shows that both V-TS and V-DS can give significantly improved dry times compared with BOC and Co. At high concentrations, the V-driers can also surpass the Co-based drier with regard to hardness after short as well as longer curing times. The combination of BOC-1101 and the V-driers can be advantageous: the two catalysts are compatible, give improved dry times together and improved hardness.

### Example #14—Curing of a Solvent-Borne Medium Oil Alkyd Resin

The purpose of this example was to find out whether the V-driers can be used in the curing of a standard solvent-borne medium oil alkyd resin (WorleeKyd S 351). Given driers are dissolved in DMSO (V-TS) and a mixture of 2-methyl-1-pentanol and isobutylacetate (V-DS).

Dry time and hardness measurements were performed as stated above in the section “Experimental details for Examples #12 to #18”.

TABLE XIII

| | | | Dry times in h | | | Hardness in s, after | | |
|---|---|---|---|---|---|---|---|---|
| # | Drier | metal % | ST | TF | DH | 1 d | 7 d | 14 d |
| 1 | BOC | 0.001 | 1.9 | 7.0 | 7.5 | 19.1 | 26.6 | 33.8 |
| 2 | Deca Cobalt 10 | 0.030 | 2.0 | 7.0 | 14.3 | 21.0 | 41.2 | 49.5 |
| 4 | V-TS | 0.010 | 1.5 | 2.3 | 7.4 | 11.2 | 25.3 | 33.2 |
| 5 | V-DS | 0.001 | 2.9 | 24.0 | 24.0 | 7.0 | 32.3 | 30.4 |
| 6 | V-DS | 0.010 | 1.4 | 2.1 | 8.9 | 11.2 | 25.2 | 34.1 |
| 7 | V-DS | 0.030 | 0.8 | 2.0 | 2.8 | 21.9 | 44.0 | 41.2 |

This example shows that the V-driers can give significantly improved dry times compared with BOC and a Co-drier, and improved hardness compared with BOC, in a standard medium oil solvent borne alkyd.

### Example 15—Curing of Other Water-Borne Alkyds

The purpose of this example was to find out whether the V-driers can be used in the curing of other water-borne alkyds. A long oil (Beckosol 101) and a medium oil (Synaqua 2070) were used. The drier V-TS was dissolved in water.

Dry time and hardness measurements were performed as stated above in the section “Experimental details for Examples 12 to 18”.

TABLE XIV

| | | | | Dry times in h | | | Hardness in s, after | | |
|---|---|---|---|---|---|---|---|---|---|
| # | Drier | Binder | metal % | ST | TF | DH | 1 d | 7 d | 14 d |
| 3 | V-TS | Beckosol 101 | 0.001 | 24.0 | 24.0 | 24.0 | 0.5 | 4.8 | 10.3 |
| 4 | V-TS | Beckosol 101 | 0.010 | 7.8 | 19.8 | 24.0 | 0.5 | 11.2 | 8.9 |
| 5 | V-TS | Beckosol 101 | 0.030 | 4.4 | 23.3 | 24.0 | 0.5 | 11.7 | 8.4 |
| 3 | V-TS | Synaqua 2070 | 0.001 | 6.4 | 24.0 | 24.0 | 0.5 | 7.9 | 7.5 |
| 4 | V-TS | Synaqua 2070 | 0.010 | 2.6 | 6.5 | 13.9 | 7.4 | 11.6 | 8.9 |
| 5 | V-TS | Synaqua 2070 | 0.030 | 2.0 | 6.9 | 22.5 | 7.0 | 9.3 | 7.9 |

The results show that V-TS can be used as a drier of water-borne long and medium oil alkyds.

### Example #16—Curing of a Full Formulation of Water-Reducible Alkyd

The purpose of this example was to find out whether the V-driers can be used in the curing of a full formulation and of a water-reducible alkyd (formulation 11Ycc). A clear coat formulation was used in this case.

Given driers are dissolved in DMSO (V-TS) and a mixture of 2-methyl-1-pentanol and isobutylacetate (V-DS).

Dry time and hardness measurements were performed as stated above in the section “Experimental details for Examples 12 to 18”.

TABLE XV

| | | | Dry times in h | | | Hardness in s, after | | | |
|---|---|---|---|---|---|---|---|---|---|
| # | Drier | metal % | ST | TF | DH | 1 d | 7 d | 14 d | 29 d |
| 1 | BOC-1101 | 0.001 | 7.0 | 24.0 | 24.0 | 14.0 | 16.4 | 16.8 | 20.6 |
| 2 | Deca Cobalt | 0.030 | 8.6 | 24.0 | 24.0 | 21.0 | 29.9 | 29.4 | 37.0 |
| | 7 aqua | | | | | | | | |
| 3 | V-TS | 0.096 | 6.9 | 23.5 | 24.0 | 15.4 | 40.2 | 51.5 | 80.6 |
| 4 | V-DS | 0.010 | 24.0 | 24.0 | 24.0 | 12.6 | 18.2 | 22.5 | 35.1 |

The results show that the V-driers are compatible with a full clear coat formulation and with water-reducible alkyds. At a medium loading (1/3 compared to Co), the long-term hardness was reaching the level of the Co-drier and was surpassing that of BOC. At a high loading, the hardness after 7 d had already surpassed that of BOC and Co and after 29 d, it was more than twice as high as that reached with Co.

### Example 17—Curing of a Pigmented Formulation of Water-Reducible Alkyd

The purpose of this example was to find out whether the V-driers can be used in the curing of a pigmented formulation of a water-reducible alkyd (formulation 11Ywp).

Given driers are dissolved in DMSO (V-TS) and a mixture of 2-methyl-1-pentanol and isobutylacetate (V-DS).

Dry time and hardness measurements were performed as stated above in the section “Experimental details for Examples 12 to 18”.

TABLE XVI

| | | | Dry times in h | | | Hardness in s, after | | | |
|---|---|---|---|---|---|---|---|---|---|
| # | Drier | metal % | ST | TF | DH | 1 d | 7 d | 14 d | 29 d |
| 1 | BOC-1101 | 0.001 | 4.0 | 24.0 | 24.0 | 14.9 | 15.9 | 16.8 | 21.1 |
| 2 | Deca Cobalt | 0.030 | 5.0 | 24.0 | 24.0 | 13.5 | 22.4 | 23.4 | 27.6 |
| | 7 aqua | | | | | | | | |
| 3 | V-TS | 0.100 | 5.0 | 18.4 | 24.0 | 9.8 | 21.5 | 30.4 | 54.8 |
| 4 | V-DS | 0.010 | 4.5 | 24.0 | 24.0 | 9.3 | 11.2 | 12.6 | 16.3 |

The results show that the V-driers are compatible with a full pigmented formulation and with water-reducible alkyds. At a medium loading (1/3 compared to Co), some loss-of-dry in the presence of pigments is observed. At a high loading, an improved dry time was observed, the hardness after 7 d had surpassed that of BOC and become equal to Co, and after 14 d, it had surpassed that of Co, becoming twice as high as that reached with Co after 29 d.

### Example 18—Curing of a Full Formulation of a Water-Based Alkyd

The purpose of this example was to find out whether the V-driers can be used in the curing of a full formulation of a water-based alkyd (vSAcc) and if they are compatible with added ligands and secondary driers, respectively.

The given V-drier is dissolved in a mixture of 2-methyl-1-pentanol and isobutylacetate.

Dry time and hardness measurements were performed as stated above in the section “Experimental details for Examples 12 to 18”.

TABLE XVII

| | | | Dry times in h | | | Hardness in s, after | | | |
|---|---|---|---|---|---|---|---|---|---|
| # | Drier | metal % | ST | TF | DH | 1 d | 7 d | 14 d | 28 d |
| 1 | BOC-1101 | 0.001 | 0.3 | 5.5 | 16.0 | 23.3 | 32.8 | 33.6 | 31.3 |
| 3 | Deca Cobalt | 0.030 | 0.6 | 5.5 | 19.4 | 25.2 | 39.3 | 44.9 | 46.8 |
| | 7 aqua | | | | | | | | |
| 5 | V-DS | 0.030 | 1.1 | 12.5 | 20.5 | 18.2 | 31.4 | 43.6 | 49.6 |
| 6 | V-DS + | 0.029 | 1.3 | 9.9 | 19.0 | 15.5 | 29.9 | 43.0 | 52.4 |
| | TACN^{a} | | | | | | | | |
| 7 | V-DS + Ca^{b} | 0.030 | 1.0 | 4.8 | 12.0 | 22.0 | 30.0 | 38.8 | n.d. |
| 8 | V-DS + Zr^{c} | 0.030 | 1.5 | 5.4 | 11.4 | 18.7 | 28.0 | 37.9 | n.d. |
| 9 | BOC-1101 + | 0.001 | 0.6 | 3.8 | 13.9 | 23.8 | 36.0 | 47.2 | 52.8 |
| | V-DS^{d} | | | | | | | | |

^{a}with addition of 1.0 equiv. TMTACN relative to the drier;
^{b}with addition of 0.2 metal % Calcium-Hydrochem;
^{c}with addition of 0.2 metal % Octa Soligen Zirconium 10 aqua;
^{d}with addition of 0.01 metal % V-DS.

The results show that the V-drier is compatible with a clear-coat water-borne formulation, with secondary driers and with additional ligands. Addition of secondary driers boosts dry time and initial hardness. Combination with the ligand TMTACN improves dry time but it boosts long-term hardness. At the same loading as Co, the V-drier surpasses the hardness reached with Co after 28 d. The highest hardness was reached with the combination of BOC and the V-drier, surpassing that of Co after 14 and 28 days. This suggests a synergy between both catalysts that provides an overall advantage to hardness and dry time.

### Example 19—Curing with Other Acids as Additives, Including Oxalic Acid, Phosphoric Acid and Hydrochloric Acid

The purpose of this example was to find out whether the V-driers can be improved in the presence of various acids, including oxalic acid, acting as an additive and ligand, respectively.

The V-drier is dissolved in an aqueous solution of oxalic acid dihydrate (8%), to give a 10 weight % solution of V-TS with 3 molar equivalents of oxalic acid relative to vanadium. Oxalic acid was found to stabilize the aqueous solution in a similar manner as acetic acid.

Dry time and hardness measurements were performed as stated above in the section “Experimental details for Examples 12 to 19”. The experiments in Table XVIII were performed in the formulation 11Ycc (experiments with an asterisk indicate a related formulation), the experiments in Table XIX in Synaqua 4804 short oil.

TABLE XVII

Hardness in s, after

| # | Drier | metal % | 1 d | 7 d | 14 d |
|---|---|---|---|---|---|
| 1 | BOC-1101 | 0.001 | 8.8 | 7.9 | 8.8 |
| 2 | Deca Cobalt 7 aqua | 0.18 | 7.0 | 21.0 | 22.4 |
| 3 | V-TS | 0.05 | 5.6 | 16.3 | 23.8 |
| 4 | V-TS + oxalic acid | 0.05 | 7.0 | 16.3 | 20.5 |

TABLE XIX

| | | | Dry times in h | | | Hardness in s, after | | |
|---|---|---|---|---|---|---|---|---|
| # | Drier | metal % | ST | TF | DH | 1 d | 7 d | 14 d |
| 1 | BOC-1101 | 0.001 | 0.9 | 24.0 | 24.0 | 14.0 | 22.4 | 23.3 |
| 2 | Deca Cobalt 7 aqua | 0.030 | 1.3 | 24.0 | 24.0 | 14.4 | 22.9 | 32.2 |
| 3 | V-TS | 0.05 | 0.6 | 11.8 | 24.0 | 14.0 | 30.3 | 35.0 |
| 4 | V-TS + oxalic acid | 0.05 | 0.8 | 15.5 | 24.0 | 15.8 | 29.0 | 35.9 |

The results in Table XVIII show that the one-day hardness in the presence of oxalic acid is improved compared with the experiment without (entries 3 and 4). There was also tested 2% of phosphoric and hydrochloric acid, respectively, instead of acetic acid (entries 5-7), which showed that also these other two acids stabilize the aqueous solution of the drier and that phosphoric acid can give improved one-day hardness. The results in Table XIX show that while oxalic acid increases the dry time a little bit, it increases the one-day hardness of the coating. While oxalic acid is illustrated above and is a C₂ dicarboxylic acid, the class of acids which should improve the hardness of the coating is not limited to just this dicarboxylic acid. In fact, it is known that acetic acid, a C₁ monocarboxylic acid is also effective. It is reasonable that all C₁-C₁₈ monocarboxylic acids and C₂-C₁₈ di-carboxylic acids would also be effective in increasing the hardness of the coating.

The inclusion of inorganic acids, e.g., phosphoric and hydrochloric acids (a completely different class of acid to those tested previously) producing increased hardness in contrast to monocarboxylic acids and di-carboxylic acids, was completely unexpected. In at least one aspect of the invention, the addition of an acid would assist in preventing the decomposition and precipitation of the drier from at least the aqueous solution. And while phosphoric and hydrochloric acids are two illustrations of an inorganic acid, there are others. Believed to be applicable in this invention, but not being limited to: are nitric acid —HNO₃, sulphuric acid—H₂SO₄, boric acid—H₃BO₃, hydrobromic acid—HBr, perchloric acid—HClO₄, hydroiodic acid—HI, etc. including combinations thereof.

In one specialized application, a combination of at least one organic acid and at least one inorganic acid is employed.

As used in this experimental aspect of the invention, the alkyd binders used were SYNAQUA 4804 (a water-borne short oil alkyd from Arkema) and TOD 3AK0211Y (a water-reducible alkyd from TOD, China). The drier solutions used were Borchi Oxy-Coat 1101 (BOC 1101, in water, Borchers) and UPA-FS2 (a vanadium-based drier, 9.4% V).

The formulations used were the following, abbreviated here as “vSAcc” and “11Ya-cc”.

TABLE XX
formulation vSAcc (Synaqua 4804-based clear coat, water borne)

| Expt. | Ingredient | Type | Amount |
|---|---|---|---|
| 1 | Synaqua 4804 | Resin | 95.0 |
| 2 | Borchi Gel 0435 | Rheology modifier | 1.5 |
| 3 | DBE-5 | Additive | 3.5 |

Resin solid content: 30.2%

TABLE XXI
formulation 11Ya-cc (TOD 3AK0211Y-
based clear coat, water borne)

| Expt. | Ingredient | Type | Amount |
|---|---|---|---|
| 1 | TOD 3AK0211Y (72% solid) | Resin | 250.0 |
| 2 | Ethanolamine | Amine | 3.4 |
| 3 | Ethylene glycol butyl ether | Solvent | 12.5 |
| 4 | deionized water | Solvent | 301.0 |
| 5 | NaNO2 20% aq. | Anti flash rust | 4.0 |
| 6 | Borchi Gol 1375, Borchers | Wetting agent | 0.5 |
| 7 | Borchi Gel 0620 (50%), Borchers | Rheology modifier | 1.0 |

Resin solid content: 31.4%

The formulation to be used for casting a film were prepared by weighing an appropriate amount of drier, usually a stock solution of defined concentration, into a plastic vial, followed by the binder solution or formulation. The amount of drier was calculated referring to the value of dry material as specified for each binder solution. Mixing was achieved by placing the vial into a speed mixer (SpeedMixer DAC 150.1 FVZ) and rotating it with 2000 rounds per minute for two minutes. Generally, a homogeneous-looking mixture was received. This was left under ambient conditions for about 24 hours before films were cast. BOC-1101 was used as received.

UPA-FS2 was used as an aqueous solution in diluted acids. All diluted acids were prepared beforehand in 2% concentration, i.e., 98% deionized water and 2% of the pure acid (acetic acid, phosphoric acid and hydrochloric acid, respectively). In the case of phosphoric acid and hydrochloric acid, the diluted solutions were prepared from 85% phosphoric acid and 4 N HCl, taking the appropriate amount of these acids and water, so that a solution of these acids with an overall concentration of 2%, referring to the pure acid, was received. All these solutions showed no sign of decomposition when stored at ambient conditions over a period of four months, in contrast to solutions in deionized water, which formed relatively large amounts of a dark precipitate within 24 hours of dissolving the solid drier.

Besides these three acids, also other acids can be used to stabilize the aqueous solutions of the vanadium driers. For example, stable aqueous solutions of vanadium driers were achieved as well, if they contained 2% of the following acids: sulfuric acid, nitric acid, boric acid, perchloric acid, hydrobromic acid and hydroiodic acid.

Furthermore, also other concentrations of acid provided stable solutions. Solutions of 10% of the V-drier V-TS in aqueous solutions containing 5% HCl and phosphoric acid, respectively, as well as 10% phosphoric acid were prepared. These three solutions did not form any precipitate over a period of four months. Also lower amounts of acid can be used, for example, a solution of 5% of V-TS in an aqueous solution of 1% H₂SO₄ was also stable.

The concentration of the V-drier is not limited to 10%. For example, a 0.5% solution of V-TS in aqueous solution of acetic acid (2%) was stable as well for a period of at least three months.

Combinations of acids can also be used. For example, stable aqueous solutions were also achieved which, for example, included 1% each of acetic and hydrobromic acid as well as 1% each of nitric and hydroiodic acid.

These results are also summarized in Table XXII.

TABLE XXII
Aqueous solutions of V-TS

| Expt. | Drier | % Drier | Acid 1 | % Acid 1 | Acid 2 | % Acid 2 | Stable |
|---|---|---|---|---|---|---|---|
| 1 | V-TS | 1.0 | — | — | — | — | No |
| 2 | V-TS | 30.0 | — | — | — | — | No |
| 3 | V-TS | 0.5 | AcOH | 2% | — | — | Yes |
| 4 | V-TS | 10 | AcOH | 2% | — | — | Yes |
| 5 | V-TS | 10 | Oxalic acid | 8% | — | — | Yes |
| 6 | V-TS | 10 | H₃PO₄ | 2% | — | — | Yes |
| 7 | V-TS | 10 | H₃PO₄ | 5% | — | — | Yes |
| 8 | V-TS | 10 | H₃PO₄ | 10% | — | — | Yes |
| 9 | V-TS | 10 | HCl | 2% | — | — | Yes |
| 10 | V-TS | 10 | HCl | 5% | — | — | Yes |
| 11 | V-TS | 5 | H₂SO₄ | 1% | — | — | Yes |
| 12 | V-TS | 10 | H₂SO₄ | 2% | — | — | Yes |
| 13 | V-TS | 10 | HNO₃ | 2% | — | — | Yes |
| 14 | V-TS | 10 | H₃BO₃ | 2% | — | — | Yes |
| 15 | V-TS | 10 | HBr | 2% | — | — | Yes |
| 16 | V-TS | 10 | HI | 2% | — | — | Yes |
| 17 | V-TS | 10 | HClO₄ | 2% | — | — | Yes |
| 18 | V-TS | 10 | AcOH | 1% | HBr | 1% | Yes |
| 19 | V-TS | 10 | HNO₃ | 1% | HI | 1% | Yes |

Stable: no-formation of a precipitate within 24-48 hours; yes: no precipitate observed over at least 48 hours, generally for 3-4 months.

Dry times were only measured for the formulation using vSAcc. “B.K. drying recorders model 3” (The Mickle laboratory engineering Co Ltd.) dry time recorder were used to measure the time required to reach the drying states of set-to-touch (ST, i.e. no longer moving freely through the soft coating but starting to rip the hardening film), tack-free (TF, i.e. no longer ripping the film but still leaving a continuous line on the coating) and dry-hard (DH, i.e. not leaving any mark on the film).

A film of 100 μm thickness was cast on a glass strip (30×2.4 cm) by using a steel cube applicator. This is then placed on the dry time recorder, a needle was put on the film, the recorder was set for measurement over 24 hours and started. The starting point where the needle was put onto the film was marked on the glass. The drying time was read from the marks left on the film after 24 hours. Dry times given as “24 h” indicate dry times of 24 h, as times longer than 24 hours could not have been determined.

Films of 100 μm thickness were cast on glass sheets (15×9 cm) for measurement of hardness at the same time as when casting films for dry time recording. These were evaluated on a pendulum hardness tester after the drying times given. Pendulum hardness was measured on a TQC Sheen Pendulum Hardness Tester SP0500 by using the König method (measuring the time of oscillations in seconds, starting at an initial amplitude of 6° and until an amplitude of 3° is reached). Softer material dampens the pendulum's oscillations more quickly than harder material, so softer material has a lower hardness value in seconds than harder material.

The coating of all glass plates, recording of dry time, measurement of hardness and storage was performed in a climate-controlled room with a temperature of 23° C. and a humidity of ca. 47-50%.

Catalyst concentrations are given in metal %, referring to the catalyst's metal amount relative to the solid content of the binder and formulation, resp., which is employed. This is also abbreviated MORS, metal on resin solid. MORS is calculated in the following way:

$$MORS = \frac{{m}_{d} \times {MC}_{d}}{\frac{{SC}_{f}}{100 \%} \times {m}_{f}}$$

with m_{d}: mass of the drier or drier solution, in g; MC_{d}: metal content of the drier (solution) in %; SC_{f}: solid content (of binder) in the formulation, in %; and m_{f}: mass of the formulation, in g.

In this application, % weight of metal in dry material content is defined as explained earlier, and the calculation also includes the solid content of other formulation components. The tables provide the approach used in the column headings, as to whether MORS was used or % weight in dry material content was used.

In the formulation vSAcc, dry times and hardness was measured (Table XXIII).

TABLE XXIII
Results in the formulation vSAcc.

| | | | Dry times | | | Hardness (König) | | | | |
|---|---|---|---|---|---|---|---|---|---|---|
| | | | in hours | | | in seconds | | | | Yellowing |
| Expt. | Drier | MORS | ST | TF | DH | 1d | 3d | 7d | 14d | b |
| 1 | BOC-1101 | 0.001 | 0.3 | 0.5 | 10.0 | 19.6 | 23.8 | 25.2 | 26.1 | 0.68 |
| 2 | V2-PA | 0.049 | 0.3 | 0.8 | 5.0 | 14.0 | 19.1 | 21.0 | 23.8 | 2.75 |
| 3 | V2-AA | 0.049 | 0.3 | 0.8 | 4.8 | 15.4 | 19.6 | 21.0 | 25.2 | 2.68 |
| 4 | V2-HCl | 0.050 | 0.3 | 0.5 | 6.3 | 14.0 | 18.6 | 21.0 | 23.8 | 2.71 |

V-TS-PA: vanadium drier (V-TS) in phosphoric acid, V-TS-AA: in acetic acid, V-TS-HCl: in hydrochloric acid. Concentration of BOC-1101: 0.001 MORS, all V-driers: 0.05 MORS.

As can be seen from the data, the dry times of the V-driers are all better than in the case of BOC, and they are only affected slightly by the nature of the acid. The best dry time was achieved with the solution in acetic acid. Also evident from the data above, is that the hardness development is also only affected slightly by the nature of the acid. The solution in acetic acid generally gave the hardest coatings within the series, only surpassed by BOC.

In the formulation 11Ya-cc, only hardness was measured (Table XXIV). Dry times were all longer than 24 hours.

TABLE XXIV
Results in the formulation 11Ya-cc.

| | | | Hardness (König) in seconds | | | | Yellowing |
|---|---|---|---|---|---|---|---|
| Expt | Drier | MORS | 1d | 3d | 7d | 14d | b |
| 1 | BOC-1101 | 0.001 | 11.7 | 10.6 | 14.0 | 14.8 | 1.66 |
| 2 | V-TS-PA | 0.050 | 8.3 | 11.2 | 17.9 | 25.3 | 5.43 |
| 3 | V-TS-AA | 0.050 | 6.9 | 9.8 | 16.5 | 25.8 | 5.61 |
| 4 | V-TS-HCl | 0.050 | 7.9 | 9.8 | 16.8 | 25.2 | 6.00 |
| 5 | V-TS-DMSO | 0.050 | 6.9 | 9.8 | 18.0 | 26.7 | 5.93 |

V-TS-PA: vanadium drier in phosphoric acid, V-TS-AA: in acetic acid, V-TS-HCl: in hydrochloric acid, V-TS-DMSO: in DMSO (no acid added). Concentration of BOC-1101: 0.001 MORS, all V-driers: 0.05 MORS.

As can be seen from the data, BOC has a higher 1-day-hardness, but after three days, the coatings with the V-driers have gained the same hardness as with BOC, while they surpass that of BOC after 7 and 14 days. The hardness development with the V-drier is only affected slightly by the nature of the acid; while the 1-day and 3-day hardness is slightly higher with the drier in phosphoric acid, the final 14-day hardness is slightly higher with the drier in acetic acid.

The use of various acids in the aqueous solutions of the vanadium driers has no detrimental effect on yellowing of the film. Instead, the choice of the acid can sometimes be utilized to achieve a certain degree of less yellowing, depending on the formulation. The b-values for yellowing are included in the above tables. For example, in the formulation 11Ya-cc, the solution of the V-drier in diluted phosphoric acid gave significantly less yellowing compared to the drier in diluted HCl.

Using a “clear” system, namely one without pigment, the results are dramatic with Table XXVI illustrating the hardness values for the formulations illustrated in Table XXV.

TABLE XXV

| | |
|---|---|
| Test Formulation | Weight % |

Grind

| | |
|---|---|
| Chempol 810-0097 | 8.16 |
| Borchi Gen 1252 | 0.41 |
| 28% Ammonia | 0.65 |
| 2-butoxy ethanol | 1.00 |
| Deionized water | 4.08 |
| AF 1171 | 0.16 |
| Kronos 2310 | 16.32 |

Letdown:

| | |
|---|---|
| Chempol 810-0097 | 24.48 |
| 28% Ammonia | 1.22 |
| 2-butoxy ethanol | 3.55 |
| Deionized water | 39.98 |
| | 100.00 |

The data in Table XXVS clearly shows quite an improvement in hardness, which may be said to be dramatic for a non-pigmented system. Without being held to any one theory or mode of operation, it is hypothesized that different formulations may benefit from having different acids with the catalyst. The choice of the acid can sometimes be utilized to achieve a certain degree of hardness, depending on the formulation.

TABLE XXVI

| Konig Hardness | 1 day | 2 day | 7 day |
|---|---|---|---|
| Vanadium 2108-A (0.05) | 15 | 17 | 18 |
| Vanadium 2108-P (0.05) | 17 | 31 | 64 |
| Vanadium 2108-A (0.1) | 14 | 15 | 15 |
| Vanadium 2108-P (0.1) | 23 | 37 | 68 |
| Vanadium 2108-A (0.05) + BOC | 21 | 22 | 21 |
| Vanadium 2108-P (0.05) + BOC | 19 | 31 | 66 |
| Vanadium 2108-A (0.1) + BOC | 23 | 23 | 21 |
| Vanadium 2108-P (0.1) + BOC | 21 | 34 | 67 |

In the following further embodiments are disclosed:

In a first embodiment a paint formulation is described comprising
a binder curable by autoxidation mechanism; and
at least one drier comprising a vanadium compound of the formula (VII)

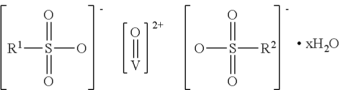

where R¹ and R² are
independently selected from a group involving hydrogen, C₁-C₁₂ alkyl, C₁-C₁₂ halogenated alkyl, C₆-C₁₀ aryl, benzyl; and whereas aryl and benzyl can be optionally substituted by up to three substituents independently selected from a group involving C₁-C₂₀ alkyl, and hydroxy(C₁-C₂)alkyl; and
at least one inorganic acid selected from the group consisting of phosphoric acid, hydrochloric acid, nitric acid, sulphuric acid, boric acid, hydrobromic acid, perchloric acid, and hydroiodic acid.

In a second embodiment of the paint formulation of the first embodiment, the binder is curable by autoxidation mechanism is selected from the group consisting of alkyd resin, epoxy ester resin and resin modified by plant oils or fatty acids.

In a third embodiment of the paint formulation of the first or second embodiments, the formulation comprises one or more sulfonate compounds of vanadium of formula (VII) in overall concentration at least 0.001 wt. % to 0.3 wt. %, preferably at least 0.003 wt. % to 0.3 wt. %, more preferably 0.006 wt. % to 0.6 wt. %, in dry material content of the paint.

In a fourth embodiment of the paint formulation of the first, second or third embodiments, the C₁-C₁₂ halogenated alkyl is a C₁-C₁₂ fluorinated alkyl.

In a fifth embodiment of the paint formulation of the first, second, third or fourth embodiments, the formulation further comprises water or wherein the formulation is non-aqueous.

In a sixth embodiment of the paint formulation of the first through fifth embodiments, the ligand is selected from the group consisting of Bispidon, N4py type, TACN-type, Cyclam and cross-bridged ligands, and Trispicen-type ligands.

In a seventh embodiment of the paint formulation of the sixth embodiment, the ligand is a bispidon ligand of Formula (I)

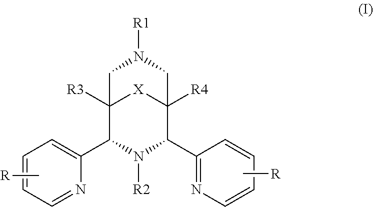

wherein:
each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄alkyl, and C₁₋₄alkyl;
R1 and R2 are independently selected from the group consisting of C₁₋₂₄alkyl, C₆₋₁₀aryl, and a group containing one or two heteroatoms (e.g. N, O or S) capable of coordinating to a transition metal;
R3 and R4 are independently selected from the group consisting of hydrogen, C₁₋₈alkyl, C₁₋₈alkyl-O—C₁₋₈alkyl, C₁₋₈alkyl-O—C₆₋₁₀aryl, C₆₋₁₀aryl, C₁₋₈hydroxyalkyl and —(CH₂)ₙC(O)OR5 wherein R5 is independently selected from hydrogen and C₁₋₄alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.
   or wherein the ligand is a N4py-type ligand of Formula (II)

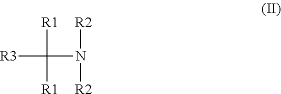

wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl;

or wherein the ligand is a TACN-type ligand of Formula (III)

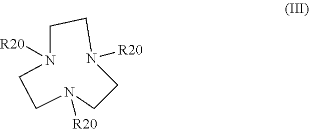

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
   wherein at least one of R20 is a —CY₂—R22;

or wherein the ligand is a cyclam or cross-bridged ligand of Formula (IV)

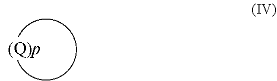

wherein:
Q is independently selected from

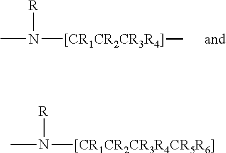

P is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy;

or wherein the ligand is a cross-bridged ligand is of the formula (V):

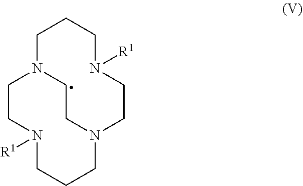

wherein
R1 is independently selected from H, C₁₋₂₀ alkyl, C₇₋₄₀-alkylaryl, C₂₋₆-alkenyl or C₂₋₆-alkynyl; or wherein the ligand is a trispicen-type ligand formula (VI):

R17R17N—X—NR17R17 (VI),

wherein:
X is selected from —CH₂CH₂—, —CH₂CH₂CH₂—, —CH₂C(OH)HCH₂—;
each R17 independently represents a group selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18;

preferably, wherein the at least one ligand is N,N,N-trimethyl-1,4,7-triazacyclononane

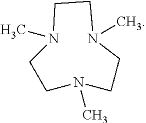

In a eighth embodiment of the paint formulation of the seventh embodiment, the metal ligand composition is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) illustrated below

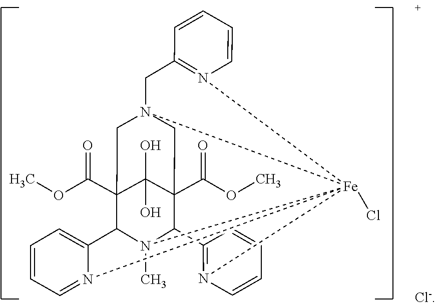

In a ninth embodiment of the paint formulation of any of the previous embodiments, the formulation further comprises a pigment.

In a tenth embodiment of the paint formulation of any of the previous embodiment, the inorganic acid is selected from the group consisting of phosphoric acid and hydrochloric acid.

In an eleventh embodiment of the paint formulation of any of the previous embodiments, the acid is a blend of at least one inorganic acid and at least one organic acid and wherein the organic acid selected from the group consisting of a C₁-C₁₈ monocarboxylic acid or a C₂-C₁₈ dicarboxylic acid and combinations thereof; and the inorganic acid selected from the group consisting of phosphoric acid, hydrochloric acid, nitric acid, sulphuric acid, boric acid, hydrobromic acid, perchloric acid, and hydroiodic acid and combinations thereof.

In a twelfth embodiment of the paint formulation of any of the previous embodiments, the alkyd resin is a solvent-borne or a water-borne resin.

In a thirteenth embodiment of the paint formulation of the first embodiment, the application for the sulfonate vanadium formulation of formula (VII) is in a paint.

In an fourteenth embodiment of the paint formulation of the first embodiment, the compound of formula (VII) is dissolved in dimethyl sulfoxide, alcohols, esters, ethers, solvents with more than one functional group of alcohols, esters, ethers or a mixture thereof before being incorporated into the paint.

In a fifteenth embodiment of the paint formulation of the first embodiment, the use of a sulfonate vanadium compound of formula (VII) is described

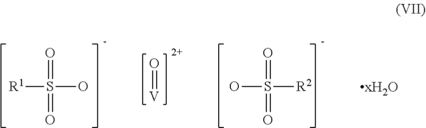

wherein R¹ and R² are
   independently selected from a group consisting of hydrogen, C₁-C₁₂ alkyl, C₁-C₈ fluorinated alkyl, C₆-C₁₀ aryl, benzyl; wherein
   the C₆-C₁₀ aryl and benzyl can be optionally substituted by one up to three substituents independently selected from a group involving C₁-C₂₀ alkyl and hydroxy(C₁-C₂)alkyl,
in dimethyl sulfoxide, alcohols, esters, ethers, solvents with more than one functional group of alcohols, esters, ethers, or a mixture thereof,
with at least one inorganic acid selected from the group consisting of phosphoric acid, hydrochloric acid, nitric acid, sulphuric acid, boric acid, hydrobromic acid, perchloric acid, and hydroiodic acid and combinations thereof, as a drier for paints containing a curable binder.

The best mode for carrying out the invention has been described for purposes of illustrating the best mode known at the time of the filing of this application. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A paint formulation comprising:
a binder curable by autoxidation mechanism;
at least one drier comprising a vanadium compound of the formula (VII) 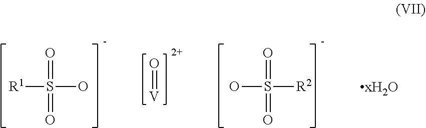
where R¹ and R² are independently selected from a group consisting of hydrogen, C₁-C₁₂ alkyl, C₁-C₁₂ halogenated alkyl, C₆-C₁₀ aryl, and benzyl; and wherein aryl and benzyl can be optionally substituted by up to three substituents independently selected from a group consisting of C₁-C₂₀ alkyl, and hydroxy(C₁-C₂)alkyl; and
at least one inorganic acid selected from the group consisting of phosphoric acid, hydrochloric acid, nitric acid, sulphuric acid, boric acid, hydrobromic acid, perchloric acid, and hydroiodic acid.

2. The paint formulation of claim 1, wherein the binder curable by autoxidation mechanism is selected from the group consisting of alkyd resin, epoxy ester resin and resin modified by plant oils or fatty acids.

3. The paint formulation of claim 1, wherein the formulation comprises one or more sulfonate compounds of vanadium of formula (VII) in overall concentration of at least 0.001 wt. % to 0.3 wt. %, in dry material content of the paint.

4. The paint formulation of claim 1, wherein the C₁-C₁₂ halogenated alkyl, when present, is a C₁-C₁₂ fluorinated alkyl.

5. The paint formulation of claim 1, wherein the formulation further comprises water.

6. The paint formulation of claim 1, further comprising a ligand selected from the group consisting of Bispidon, N4py type, TACN-type, Cyclam and cross-bridged ligands, and Trispicen-type ligands.

7. The paint formulation of claim 6, wherein the ligand is a bispidon ligand of Formula (I) 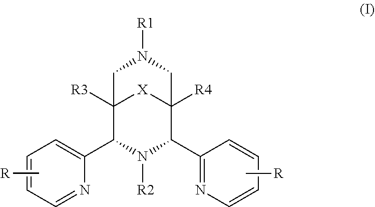
wherein:
each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄ alkyl, and C₁₋₄ alkyl;
R1 and R2 are independently selected from the group consisting of C₁₋₂₄ alkyl, C₆₋₁₀ aryl, and a group containing one or two heteroatoms (e.g. N, O or S) capable of coordinating to a transition metal;
R3 and R4 are independently selected from the group consisting of hydrogen, C₁₋₈ alkyl, C₁₋₈ alkyl-O—C₁₋₈ alkyl, C₁₋₈ alkyl-O—C₆₋₁₀ aryl, C₆₋₁₀ aryl, C₁₋₈ hydroxyalkyl and —(CH₂)ₙC(O)OR5 wherein R5 is independently selected from hydrogen and C₁₋₄ alkyl,
n is from 0 to 4,
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.

8. The paint formulation of claim 7, wherein the bispidon ligand is:
iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) illustrated below

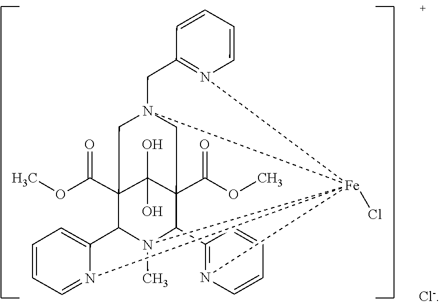

9. The paint formulation of claim 1, which further comprises: a pigment.

10. The paint formulation of claim 1, wherein the inorganic acid is selected from the group consisting of phosphoric acid and hydrochloric acid.

11. The paint formulation of claim 1, wherein the paint formulation comprises a blend of the at least one inorganic acid and at least one organic acid and wherein
the organic acid is selected from the group consisting of
a C₁-C₁₈ monocarboxylic acid or a C₂-C₁₈ dicarboxylic acid and combinations thereof; and
the inorganic acid is selected from the group consisting of
phosphoric acid, hydrochloric acid, nitric acid, sulphuric acid, boric acid, hydrobromic acid, perchloric acid, and hydroiodic acid and combinations thereof.

12. The paint formulation of claim 2, wherein the binder curable by autoxidation mechanism is an alkyd resin, and the alkyd resin is a solvent-borne or a water-borne resin.

13. (canceled)

14. The use of a sulfonate vanadium compound formula (VII) as defined in claim 1, wherein the compound of formula (VII) is dissolved in dimethyl sulfoxide, alcohols, esters, ethers, or solvents with more than one functional group of alcohols, esters, ethers, or a mixture thereof before being incorporated into a paint.

15. The use of a sulfonate vanadium compound of formula (VII): 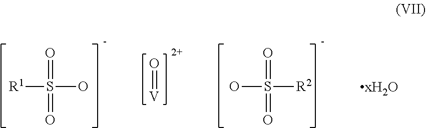
wherein R¹ and R² are
independently selected from the group consisting of hydrogen, C₁-C₁₂ alkyl, C₁-C₈ fluorinated alkyl, C₆-C₁₀ aryl, and benzyl; wherein
the C₆-C₁₀ aryl and benzyl can be optionally substituted by one up to three substituents independently selected from the group consisting of C₁-C₂₀ alkyl and hydroxy(C₁-C₂)alkyl,
in dimethyl sulfoxide, alcohols, ethers, or solvents with more than one functional group of alcohols, esters and ethers, or a mixture thereof,
with at least one inorganic acid selected from the group consisting of phosphoric acid, hydrochloric acid, nitric acid, sulphuric acid, boric acid, hydrobromic acid, perchloric acid, and hydroiodic acid and combinations thereof,
as a drier for paints containing a curable binder.

16. The paint formulation of claim 3, wherein the formulation comprises one or more sulfonate compounds of vanadium of formula (VII) in overall concentration of at least 0.006 to 0.06 wt. %, in dry material content of the paint.

17. The paint formulation of claim 1, wherein the formulation is non-aqueous.

18. The paint formulation of claim 6, wherein the ligand is a or wherein the ligand is a N4py-type ligand of Formula (II): 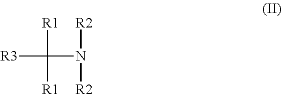
wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

19. The paint formulation of claim 6, wherein the ligand is a TACN-type ligand of Formula (III): 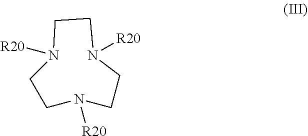
wherein
each is independently selected from: C₁₋₈-alkyl, C₃₋₈-cycloalkyl,
R20 heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
wherein at least one of R20 is a —CY₂—R22.

20. The paint formulation of claim 6, wherein the ligand is a cyclam or cross-bridged ligand of Formula (IV): 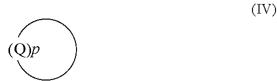
wherein:
Q is independently selected from 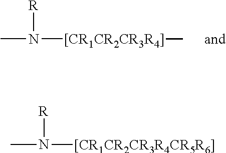
P is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy;
or wherein the ligand is a cross-bridged ligand is of the formula (V): 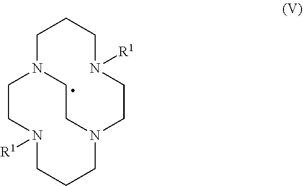
wherein
R¹ is independently selected from H, C₁₋₂₀ alkyl, C₇₋₄₀-alkylaryl, C₂₋₆-alkenyl or C₂₋₆-alkynyl.

21. The paint formulation of claim 6, wherein or wherein the ligand is a trispicen-type ligand formula (VI):
R17R17N—X—NR17R17 (VI),
wherein:
X is selected from —CH₂CH₂—, —CH₂CH₂CH₂—, —CH₂C(OH)HCH₂—;
each R17 independently represents a group selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.
